(19) United States
(12) Patent Application Publication
(10) Pub. No.: US 2025/0277067 A1
(43) Pub. Date: Sep. 4, 2025

(54) POLY(METH)ACRYLAT IMPACT MODIFIER WITH IMPROVED OPTICAL PROPERTIES AND METHOD FOR ITS PRODUCTION

(71) Applicant: Röhm GmbH, Darmstadt (DE)

(72) Inventors: Johannes Vorholz, Alzenau (DE); Ann-Kathrin Danner, Mainz (DE); Michael Schnabel, Biebesheim (DE); Ralf Richter, Hanau (DE)

(73) Assignee: Röhm GmbH, Darmstadt (DE)

(21) Appl. No.: 18/858,475

(22) PCT Filed: Apr. 25, 2023
(86) PCT No.: PCT/EP2023/060785

§ 371 Date: Oct. 21, 2024

(30) Foreign Application Priority Data
Apr. 28, 2022 (EP) 22170493.5

(51) Int. Cl. C08F 20/14; C08K 3/08

(52) U.S. Cl. CPC C08F 20/14; C08K 3/08; C08K 2003/0812; C08K 2003/0818; C08K 2003/0825; C08K 2003/0893

(57) ABSTRACT

Poly(meth)acrylate impact modifiers having at least one multiphase alkyl (meth)acrylate emulsion polymer with at least one multivalent metal ion, and a defined amount of alkali metal ions improve the optical properties of moulding compositions produced thereof. One improved property is a high transparency after hot water storage. A method for producing the poly(meth)acrylate impact modifiers include the preparation of at least one multiphase alkyl (meth)acrylate polymer via emulsion polymerization, the coagulation and mechanical dewatering of the obtained latex.

The present invention is directed to poly(meth)acrylate impact modifiers comprising at least one multiphase alkyl (meth)acrylate emulsion polymer comprising at least one multivalent metal ion, for example selected from alkaline earth metal, zinc and aluminium, and a defined amount of alkali metal ions, wherein the impact modifiers or moulding composition produced thereof have improved optical properties, in particular high transparency after hot water storage. The impact modifiers comprise less than or equal to 3.0 mmol/kg, based on the solid content of the impact modifier, of alkali metal ions, and exhibit a molar ratio of alkali ions to multivalent metal ions of less than or equal to 1.3.

Furthermore, the present invention is directed to a method for producing the poly(meth)acrylate impact modifier comprising the preparation of at least one multiphase alkyl (meth)acrylate polymer via emulsion polymerization, the coagulation and mechanical dewatering of the obtained latex, wherein the amounts of alkali ions and multivalent metal ions, that typically originate from coagulants and other auxiliaries, in the dewatered alkyl (meth)acrylate emulsion polymer are controlled.

The invention also relates to impact-modified moulding compositions, especially impact-modified poly(methyl methacrylate) (PMMA) compositions, having improved profile of properties, including good optical properties, in particular high transparency after hot water storage. The moulding compositions are preferably used for producing moulded articles and semi-finished products, such as films and sheets, in particular transparent articles and semi-finished products or products with good optical appearance.

### STATE OF THE ART

It is known that the impact resistance of moulding compositions, especially of relatively brittle synthetic resins, such as poly(meth)acrylate moulding compositions, can be improved by incorporating a suitable amount of so-called impact modifiers. It has become established practice in industry to use impact modifiers produced by emulsion polymerization, known as core, core-shell, or core-shell-shell particles. These generally includes an elastomeric phase, e.g. as core or as an intermediate shell grafted onto the core, and a hard outer phase, which typically ensures good incorporation of the impact modifier particles into the matrix polymer. Such multiphase emulsion polymers and their preparation are for examples described in WO 2004/056893.

Typically, such impact modifiers produced by emulsion graft polymerization are obtained as aqueous polymer dispersion (latex), which needs to be worked-up via coagulation and separation of the emulsion polymer. Several methods of coagulation (also referred to as precipitation) of polymer latices are well known and described in the state of the art.

Generally, it is described that emulsion polymers, such as poly(meth)acrylate impact modifiers of the present invention, can be coagulated by means of known physical coagulation processes, such as shear coagulation, thermal shear coagulation, spray drying, freeze coagulation or pressure coagulation processes, or by means of chemical coagulation processes, which includes the addition of electrolytes, in particular multivalent cations, e.g. alkaline earth metal salts, aluminium salts or zinc salts, or inorganic or organic acids.

For example, the coagulation of an aqueous polymer dispersion by means of continuous or semi-continuous freezing coagulation and the subsequent mechanical dewatering, e.g. using centrifugation step, are described in WO 2015/074883. The coagulation and dewatering of emulsion polymers via thermal shear coagulation in an extruder line are for example described in WO 02/184539, EP 0 683 028, and EP 0 187 715. In EP 0 467 288 it is described that an acrylic moulded product comprising an acrylic polymer freeze-coagulated material shows better extrusion stability compared to coagulated material obtained by spray-drying or using a common chemical coagulant, such as aluminium chloride, sodium chloride, magnesium sulfate or sulfuric acid.

Often the process of coagulation and dewatering of emulsion polymers, in particular in an extruder system, suffers from the problem that the separated aqueous phase often has an undesirably high polymer concentration. This constitutes a particular disadvantage, as this leads to high loads (chemical oxygen demand (COD values)) on the clarifying plant during wastewater treatment and to a loss of polymer product. Thus, there is a need to provide an improved method that leads to a reduction of the polymer concentration in the separated aqueous phase and the wastewater.

Another common way for coagulation of emulsion polymers is mixing the emulsion polymer (latex) with a coagulant, which is often selected from aqueous solutions of metal salts, in particular bivalent or trivalent metal ions, and/or acids, such as sulfuric acid, acetic acid, phosphorus acid. For example, aqueous solutions of alkaline metal salts, alkaline earth metal salts, zinc salts or aluminium salts, such as magnesium sulfate, calcium chloride, and aluminium chloride are used as coagulants.

The document JPH03247603 describes a process of coagulating a latex of a graft polymer, wherein the latex and a conventional coagulant are mixed with a co-rotating twin-screw kneader. The coagulant may for example be selected from sodium chloride, calcium chloride, magnesium chloride, sodium sulfate, magnesium sulfate, several carbonates, aluminium salts and acids. The coagulant may be added in the process in an amount of 0.05 to 50% by weight, based on the solid content of the polymer latex. The latex polymer can for example be a graft copolymer of butyl acrylate grafted with methyl methacrylate. The amount of alkali metal ions or alkaline earth metal ions in the dewatered graft polymer is not mentioned in JPH03247603.

The document JP 2000-119476 describes an acrylic multilayer structural polymer which is obtained from coagulating an emulsion polymer latex using a coagulant wherein the residual amount of cation derived from the coagulant is not more than 200 ppm. The coagulant is typically one selected from magnesium sulfate, calcium chloride and aluminium sulfate. Typically, the coagulation is effected by mixing the emulsion polymer latex with an aqueous solution of magnesium sulfate, calcium chloride or aluminium sulfate. The acrylic multilayer structural polymer is composed of a hard, outer layer comprising methacrylate ester units and a soft inner layer comprising acrylate ester units. A known anionic surfactant, e.g. sodium stearic acid, sodium myristate, sodium dioctylsulfosuccinate, sodium dodecylbenzenesulfonate, sodium dodecylbenzenesulfonate, sodium lauryl sulfate, can be used in the emulsion polymerization of the acrylic multilayer structural polymer. JP 2000-119476 describes that the coagulated polymer is washed until the desired amount of magnesium or calcium ions is obtained. The amount of alkali metal ions or the ratio of alkali metal ions to alkaline earth metal ions is not mentioned in JP 2000-119476.

The document JP 2005-171141 describes a latex with improved dewatering behaviour containing a multilayer structural polymer suitable for a modifier, a film or a moulding material. The latex of JP 2005-171141 has a solid content from 35 to 42% by weight and the multilayer polymer particles in the latex exhibits a mass average particle diameter of 0.100-0.770 μm. Further, J P 2005-171141 describes a method for coagulating and covering the multilayer polymer from the latex wherein the coagulation is effected by contacting the latex with an aqueous solution of a coagulant, such as sulfuric acid, hydrochloric acid, calcium chloride, magnesium sulfate, calcium formate, and calcium acetate. Further, the addition of a buffer, including alkali metals or alkaline earth metals is mentioned. For example, calcium acetate is added as coagulant in an amount of 1.0 to 4.0% by mass based on 100 parts by mass of the solid content of the multilayer polymer latex. The formation of scale (i.e. calcium carbonate deposition) is determined by filtering the multilayer polymer latex through a 150 μm metal mesh and collecting the scale from the inner wall of the polymerization reactor. The amount of alkali metal salts or alkaline earth metal salts in the dewatered polymer or in the final polymer product is not mentioned in JP 2005-171141.

The document EP 0 187 715 describes a process for coagulating an aqueous polymer latex by contacting the aqueous polymer latex with an aqueous solution of water-soluble, non-nucleophilic, non-oxidative alkaline earth metal and/or zinc salt and recovering the coagulated polymer. The coagulant is used in an effective amount of 0.05 of 5% by weight, based on weight of latex polymer solids. For example, calcium acetate or calcium hypophosphite is used as coagulant. For example, the polymer latex is contacted with the coagulant in an extruder encompassing a coagulating zone, a dewatering zone and a devolatilization zone. It is described that the water haze value, yellowness index and light transmission should be improved by the process of EP 0 187 715. The amount of alkali metal salts or alkaline earth metal salts in the dewatered polymer or in the final polymer product is not mentioned in EP 0 187 715.

The document EP 0 465 049 described blends of poly(methyl methacrylate) and heterogeneous core/shell polymer having a alkyl acrylate polymer stage and a alkyl methacrylate polymer shell, wherein the colour of the polymer blend should be improved when the core/shell polymer is treated with a phosphorus-containing reducing agent. Particularly, EP 0 465 049 discloses the addition of sodium hypophosphite or calcium hypophosphite to an emulsion polymer before coagulation via freeze-drying or spray drying. For example, the hypophosphite reducing agent is added in an amount of 0.025 to 0.10%, calculated on solid/solid basis. However, the amount of alkali metal salts or alkaline earth metal salts in the dewatered polymer or in the final impact modifier is not mentioned in these examples. Further, EP 0 465 049 described the dry blending of the PMMA matrix polymer, the impact modifier powder, and sodium hypophoshite, wherein the amount of sodium hypophoshite (NaH₂PO₂) is 50 to 200 ppm, based on the polymer blend (matrix polymer/impact modifier=1:1).

The document EP 2 189 497 A1 relates to polymer compositions comprising a multistage copolymer, a phosphate salt of a multivalent cation, which was added in particular for coagulation of the multistage copolymer latex, as well as 100 ppm or more of alkaline phosphate, calculated as phosphorous based on dry multistage copolymer. In particular, EP 2 189 497 A1 describes the preparation and coagulation of a multistage graft copolymer, having a crosslinked butadiene/styrene core, wherein the coagulated and washed multistage graft copolymer is treated with di-sodium hydrogenphosphate (Na₂HPO₄), and wherein di-sodium hydrogenphosphate is added in excess to the calcium ions, so that no calcium chloride remains and all calcium ions are present in the form of calcium phosphate. After said treatment the multistage graft copolymer is dried and incorporated as an impact modifier in an amount of 5 wt.-% in polycarbonate molding compositions. As a consequence, said multistage copolymer comprises large amounts of sodium ions.

The document EP 3 747 914 A1 describes a multilayered acrylic polymer coagulate characterized via its bulk density, particle diameter, wherein the amount of alkali and earth alkali metal N (in mmol/kg) is defined based on the glass transition temperature Tg (in ° C.) of the acetone-soluble matter of the coagulate and valency of the alkali and earth alkali metal a via the formula Σ(N/a)*(120−Tg)≤100. The multilayered acrylic polymer coagulate of D1 shall exhibit excellent transparency, resistance to hot water whitening and stress-whitening.

The document EP 2 942 360 describes a thermoplastic resin powder obtained by coagulating a polymer latex produced by means of emulsion polymerization using a phosphoric acid ester as emulsifying agent, wherein the content of free acid in the resin is not greater than 500 ppm. EP 2 942 360 describes that the presence of polyvalent metal ions in the thermoplastic resin powder results in reduction of the fluidity of the thermoplastic resin powder, and therefore the amount of coagulant should be as less as possible. It is described that the thermoplastic resin powder comprises less than 50 ppm calcium, preferably less than 50 ppm calcium and magnesium in sum, and 60 to 300 ppm aluminium and more than 50 ppm phosphorus. For example, aluminium sulfate or sulfuric acid is used as coagulants. The amount of alkali metal ions is not discussed in EP 2 942 360.

The document GB 2 226 324 A describes a clear viscous moulding composition comprising 10 to 90% of a hard phase made of methyl methacrylate and 1 to 90% of a viscous phase distributed in the hard phase, e.g. made of a crosslinked butyl acrylate polymer, wherein the moulding composition comprises not more than 0.05% by weight of water-soluble components. It is described that the aqueous phase is separated off in liquid form from the coagulate to such an extent that not more than 0.05% by weight of water-soluble constituents remain in the composition in order to ensure permanent clarity, particularly under the effect of moisture.

The document WO 2013/160029 describes a polymer composition containing at least graft polymer B1 produced by emulsion polymerisation and optionally a thermoplastic polymer A, a rubber-free vinyl(co)polymer and other polymers or polymer additives. The emulsion graft copolymer is precipitated with at least one alkaline earth metal salt in basic medium and comprises at least one sodium salt and at least one alkaline earth metal salt in a molar ratio Na/(Mg+Ca) of at least 0.10 and at most 1.0. It is described that the mouldings prepared from said emulsion graft copolymer B1 should have improved surface quality after storage under warm-humid conditions. WO 2013/160029 teaches to reduce the amount of alkaline earth metal salt, that originates from coagulant, and, if necessary, to increase the amount of sodium by the addition of a sodium salt, e.g. sodium phosphate, during the emulsion polymerisation and/or the coagulation process. The examples of WO 2013/160029 disclose pre-compounds of 50% by weight of an acrylonitrile/butadiene/styrene (ABS) emulsion graft copolymer and a thermoplastic styrene/acrylonitrile copolymer (SAN), wherein the ABS emulsion graft copolymer comprises potassium ions in an amount of 130 or 100 ppm and sodium ions in an amount of 35 or 110 ppm. WO 2013/160029 does not describe an emulsion graft copolymer having a content of alkaline metal ions of less than 3 mmol/kg.

Particularly important properties of impact-modified PMMA moulding compositions are advantageous mechanical properties such as high toughness (impact resistance, notched impact resistance), high elasticity (modulus of elasticity), as well as good processability (thermoplastic flowability, MVR), and good weathering and heat resistance. Furthermore, a fundamental requirement placed upon PMMA moulding compositions and articles is optical transparency even at elevated temperature or after exposure to hot water. Generally, products that are considered to be optically clear are those with a haze value smaller than or equal to 15.0%, in particular below 10.0% and very particularly below 6.0%, measured by means of a BYK Gardner Hazegard-plus hazemeter, measured at 23° C. on test specimen having a thickness of 1 mm according to standard ASTM D1003 (2013).

Often it is a problem that the impact modified PMMA moulding compositions and articles made thereof show reduced transparency and become milky white after storage in hot water, in particular after 10-24 hours in water of 80° C. Thus, there is a great need to provide impact modified PMMA moulding compositions showing reduced haze and high optical transmission after hot water storage.

### OBJECT OF THE INVENTION

One object of the invention is to provide a poly(meth)acrylate impact modifier, as well as moulding compositions, moulded articles and semi-finished products, such as films and sheets, comprising the poly(meth)acrylate impact modifier, which have improved optical properties, in particular high transparency and high transmission. Particularly, the impact modifier should cause lower haze values, measured at 23° C. on test specimen having a thickness of 1 mm according to standard ASTM D1003 (2013), in particular after hot water storage at 70° C. and 80° C., compared to the prior art modifiers. Further, the impact modifier should exhibit high optical transmission values, even after hot water storage at 70° C.-80° C., e.g. for 4-24 hours. Particularly, it is an object of the invention to obtain semi-finished products, preferably transparent semi-finished products, which have an ASTM 1003-13 haze of <30%, preferably <20%, after hot water storage at 70° C., preferably after hot water storage at 80° C., e.g. for 4-24 hours.

Another object of the invention is to provide a cost effective and easy process for producing poly(meth)acrylate impact modifiers and/or impact modified polymer compositions. In particular it is an object of the invention to facilitate and optimize the separation of the polymer from the aqueous phase, wherein the polymer content in the wastewater from dewatering is reduced.

### SOLUTION ACCORDING TO THE INVENTION

It was surprisingly found that the haze after hot water storage of impact modifiers or transparent articles made thereof is reduced when the amount of alkali ions in the impact modifier, in particular after coagulation and dewatering, is reduced to or under a critical value of about 3.0 mmol/kg, preferably 2.5 mmol/kg, more preferably under 2.0 mmol/kg, based on dry impact modifier, and simultaneously the molar ratio of alkali ions to multivalent metal ions, preferably selected from alkaline earth metal, zinc and aluminium, is adjusted to be less than or equal to 1.3, preferably less than or equal to 1.2. Further, typically the inventive impact modifier or test specimens comprising it shows high optical transmission values, even after hot water storage.

Typically, said alkali metal ions results from additives, such as emulsifiers, initiators and buffers, used in emulsion polymerization. Generally, the salt content in the coagulated polymer can be reduced by washing and/or by a higher degree of dewatering. In this context it was surprisingly found, that such desired low amount of alkali metal ions can be obtained by the addition of a multivalent metal ion salt, such as an alkaline earth metal salt (e.g. calcium acetate or calcium hydroxide) or an aluminium salt, before or during coagulation, but not after coagulation. In particular, it was found that a combination of a specified maximum amount of alkali metal ions and a minimum amount of multivalent metal ions, such as alkaline earth metal ions or aluminium ions, which are typically added before coagulation of the emulsion polymer, improves the hot water storage stability of the impact modifier. In addition, a preferred minimum amount of more than or equal to 0.5 mmol/kg, preferably 2.0 mmol/kg, of multivalent metal ions are advantageous.

Furthermore, it has been found that the amount of polymer in the wastewater formed by the separated aqueous phase is significantly reduced if the specific values of alkali metal ions and molar ratio of alkali ions to multivalent metal ions in the dewatered polymer are met.

### DESCRIPTION OF THE INVENTION

The present invention is directed to a poly(meth)acrylate impact modifier (also referred to as impact modifier in the following) comprising (preferably consisting essentially of) at least one multiphase alkyl (meth)acrylate emulsion polymer (also referred to as emulsion polymer in the following), wherein the poly(meth)acrylate impact modifier comprises at least one multivalent metal ion and less than or equal to 3.0 mmol/kg, preferably less than or equal to 2.5 mmol/kg, more preferably less than or equal to 2.0 mmol/kg, based on the solid content of the impact modifier, of alkali metal ions, and wherein the molar ratio (in the a poly(meth)acrylate impact modifier) of alkali ions to multivalent metal ions, preferably selected from alkaline earth metals, zinc and aluminium, is less than or equal to 1.3, preferably less than or equal to 1.2.

Typically, the metal ions contained in the inventive impact modifiers arise from auxiliaries used in the emulsion polymerization process of the multiphase alkyl (meth)acrylate emulsion polymer, such as initiators, surfactants, and buffer salts. Typically, a significant amount of metal ions in the impact modifier arises from coagulants used for isolation of the emulsion polymer from the aqueous latex dispersion. Furthermore, metal ions may arise from additives, such as stabilizers, added to the impact modifier. In particular, the alkali metal ions included in the inventive impact modifier arise from initiators and/or surfactants used in emulsion polymerization. In particular, the multivalent ions, e.g. alkaline earth metal ions, included in the inventive impact modifier arise from a coagulant comprising at least one salt of a multivalent metal ion, e.g. an alkaline earth metal salt, which is added before coagulation.

The term “multivalent metal” or “multivalent metal ion” is directed to metal ions having two or more, preferably two or three, ionic charges. Preferably, the multivalent metal ions may be selected from metals of the IUPAC group 2 (alkaline earth metals) and the IUPAC groups 8 to 14, more preferably from metals of the IUPAC group 2 (alkaline earth metals), the IUPAC group 12 (zinc group) and the IUPAC group 13 (boron group).

The term “alkali metal” or “alkali metal ion” includes the elements of IUPAC group 1 of the periodic table of elements, in particular lithium (Li), sodium (Na), and potassium (K). The term “alkaline earth metal” or “alkaline earth metal ion” includes the elements of IUPAC group 2 of the periodic table of elements, in particular magnesium (Mg), calcium (Ca), strontium (Sr) and barium (Ba).

The term “(meth)acrylate” as used herein is meant to encompass methacrylates, acrylates and mixtures thereof.

The term “alkyl (meth)acrylate polymer” means a polymer comprising at least 30% by weight, preferably at least 40% by weight, more preferably at least 50% by weight, of alkyl (meth)acrylate monomer units and includes copolymers of alkyl (meth)acrylate monomers with one or more other co-polymerizable monomer.

The term “alkyl (meth)acrylate emulsion polymer” means a multiphase emulsion polymer comprising at least 30% by weight, preferably at least 40% by weight, more preferably at least 50% by weight, of alkyl (meth)acrylate monomer units in the outer shell, wherein the outer shell may include copolymers of alkyl (meth)acrylate monomers with one or more other co-polymerizable monomer, for example styrene.

The term “aqueous” or “aqueous solution” means that the medium or solvent consists of water or comprises water as main component. For example, a polar water-miscible co-solvent, e.g. alcohol, may be included in the medium or solvent.

The term “latex” used in connection with the present invention means water-insoluble polymer with is dispersed in an aqueous phase, preferable stabilized by one or more surfactants, and which is prepared by conventional polymerization techniques, preferably by emulsion polymerization.

If not defined otherwise, the term ppm means mg/kg according to the present invention. For example, the term ppm means mg/kg, based on the solid content of the poly(meth)acrylate impact modifier.

The content of metal ions, e.g. alkaline metals and multivalent metal ions, e.g. alkaline earth metals, in the emulsion polymer or in the impact modifier is typically determined via atom emission spectroscopy after chemical digestion of the polymer sample, for example after microwave-assisted digestion of the polymer sample in nitric acid. The amount of alkali metal and multivalent metal, e.g. alkaline earth metal or aluminium, is typically given in consideration of the limit of detection of the respective analysis method. For example, an amount given with 0% by weight or 0 mmol/kg is understand as being below the limit of detection of the respective analysis method.

Preferably, the at least one multivalent metal ion is selected from metal ions from IUPAC group 2 (alkaline earth metals), IUPAC groups 12 (zinc group) and IUPAC group 13 (boron group). More preferably, the multivalent metal ion is selected from alkaline earth metals, preferably magnesium (Mg) and/or calcium (Ca), and metals of the IUPAC group 13, preferably aluminium. Most preferably the multivalent metal ion is selected from alkaline earth metals, zinc (Zn), and aluminium (Al). In a further preferred embodiment, the at least on multivalent is selected from magnesium (Mg), calcium (Ca), zinc (Zn) and aluminium (Al), more preferably from magnesium (Mg), calcium (Ca) and aluminium (AI).

In a preferred embodiment the alkali metal ion is selected from sodium ion and potassium ion, and the at least one multivalent ion is selected from alkaline earth metal, aluminium and zinc, more preferably from calcium, magnesium, and aluminium.

In particular the amount of alkali metal ions is directed to the sum of all alkali metal ions present in the poly(meth)acrylate impact modifier. In particular the amounts of multivalent metal ions, e.g. alkaline earth metal ions and/or aluminium ions, are directed to the sum of all multivalent metal ions, e.g. alkaline earth metal ions and/or aluminium ions, present in the poly(meth)acrylate impact modifier. Preferably, the alkali metal ions are sodium ions and/or potassium ions and the amount of alkali metal ions is directed to the sum of sodium ions and potassium ions. Preferably, the multivalent metal ions are magnesium ions, calcium ions and/or aluminium ions, and the amount of multivalent metal ions is directed to the sum of magnesium ions, calcium ions and aluminium ions.

The at least one alkali metal ion and the at least one multivalent metal ion, e.g. alkaline earth metal ion or aluminium ion, may be present in the impact modifier in any arbitrary form, such as in form of a solid salt or salt inclusion, dissolved in an aqueous phase, bound or adsorbed to other components or groups, e.g. anionic groups, of the emulsion polymer.

Preferably, the poly(meth)acrylate impact modifier comprises from 0 to 3.0 mmol/kg, preferably from 0 to 2.5 mmol/kg, more preferably from 0 to 2 mmol/kg, also preferably from 0.01 to 3.0 mmol/kg, also preferably from 0.01 to 2.0 mmol/kg, based on the solid content of the impact modifier, of alkali metal ions.

Preferably, the poly(meth)acrylate impact modifier comprises from 0.5 to 20.0 mmol/kg, preferably from 1.0 to 10.0 mmol/kg, more preferably from 2.0 to 8.0 mmol/kg, based on the solid content of the impact modifier, of multivalent metal ions, e.g. alkaline earth metal ions and/or aluminium ions.

Preferably, the poly(meth)acrylate impact modifier comprises less than or equal to 3.0 mmol/kg, preferably less than or equal to 2.5 mmol/kg, based on the solid content of the impact modifier, of alkali metal ions; and more than or equal to 0.5 mmol/kg, preferably more than or equal to 1.0 mmol/kg, more preferably more than or equal to 2.0 mmol/kg, also preferably more than or equal to 3.0 mmol/kg, based on the solid content of the impact modifier, of at least one multivalent metal ion.

In a particular preferred embodiment the poly(meth)acrylate impact modifier comprises from 0 to 3.0 mmol/kg, preferably from 0 to 2.5 mmol/kg, also preferably from 0.01 to 3.0 mmol/kg, particularly preferred from 0.1 to 2.0 mmol/kg, based on the solid content of the impact modifier, of alkali metal ions, and from 0.5 to 20.0 mmol/kg, preferably from 1.0 to 10.0 mmol/kg, more preferably from 2.0 to 8.0 mmol/kg, based on the solid content of the poly(meth)acrylate impact modifier, of multivalent metal ions, e.g. alkaline earth metal ions and/or aluminium ions.

The molar ratio of alkali ions to multivalent ions (e.g. alkaline earth metal ions and/or aluminium ions) is less than or equal to 1.3; preferably less than or equal to 1.2; preferably less than or equal to 1.0; more preferably less than or equal to 0.8, more preferably less than or equal to 0.7, in the inventive impact modifier. Particular preferably, the molar ratio of alkali ions to multivalent ions (e.g. alkaline earth metal ions and/or aluminium ions) is in the range of 0 to 1.3, also preferably in the range of 0.01 to 1.3, more preferably in the range of 0.1 to 1.3.

In particular, the molar ratio of multivalent ions (e.g. alkaline earth metal ions and/or aluminium ions) to alkali ions is more than or equal to 0.8, preferably more than or equal to 0.9, also preferably more than or equal to 1.0, more preferably more than or equal to 2.0, in the inventive impact modifier. Particular preferably, the molar ratio of multivalent ions (e.g. alkaline earth metal ions and/or aluminium ions) to alkali ions is in the range of 0.8 to 20, preferably in the range of 0.9 to 10.

In a preferred embodiment the poly(meth)acrylate impact modifier comprises less than or equal to 3.0 mmol/kg, preferably less than or equal to 2.5 mmol/kg, also preferably less than or equal to 2.0 mmol/kg, based on the solid content of the impact modifier, of sodium ions and/or potassium ions; and more than or equal to 1.0 mmol/kg, preferably more than or equal to 2.0 mmol/kg, also preferably more than or equal to 3.0 mmol/kg, based on the solid content of the impact modifier, of magnesium ion, calcium ions and/or aluminium ions. Typically, the amounts refer to the sum of the alkali metal ions or respectively to the sum of magnesium ion, calcium ions and/or aluminium ions present in the impact modifier.

Typically, impact modifier comprises or essentially consists of polymer particles which are prepared by emulsion polymerization. After emulsion polymerization said impact modifier is in the form of an aqueous polymer dispersion at the end of the synthesizing step. This aqueous polymer dispersion is also referred to as latex and contains not only the polymer fraction but also polar, water-soluble auxiliary materials, such as surfactants, buffer substances, initiators and other redox components, that are needed to carry out the polymerization step.

### Multiphase Alkyl (Meth)Acrylate Emulsion Polymer

Preferably, the multiphase alkyl (meth)acrylate emulsion polymer is an emulsion polymer obtained by emulsion polymerization, preferably by sequentially emulsion polymerization, of alkyl (meth)acrylate monomers and optionally other copolymerizable monomers, wherein the emulsion polymer has a multiphase structure, which comprises at least one core and at least one, preferably one or two, shells.

For example, the multiphase alkyl (meth)acrylate emulsion polymer may be formed by crosslinked particles having core-shell structure or core-shell-shell structure. Typically, the particles have an average particle diameter between 20 nm and 500 nm, preferably between 50 nm and 450 nm, more preferably between 100 nm and 400 nm and most preferably between 150 nm and 350 nm. Average particle diameter can be determined by a method known to a skilled person, e.g. via static or dynamic light scattering, such as laser diffraction measurements or photon correlation spectroscopy according to DIN ISO 13321:1996. Typically, volume-averaged particle diameters can be obtained from light scattering measurements.

In one preferred embodiment the multiphase alkyl (meth)acrylate emulsion polymer comprises a soft, elastomeric core and a hard, non-elastomeric outer phase, which is produced in the presence of the core, typically via graft emulsion polymerization. Said multiphase alkyl (meth)acrylate emulsion polymer is referred to as core-shell emulsion polymers in the following. For example, the soft, elastomeric core may be based on polybutadiene or crosslinked C₁-C₁₀ alkyl acrylate polymer, such as crosslinked polybutylacrylate.

In another preferred embodiment the multiphase alkyl (meth)acrylate emulsion polymer comprises a hard, non-elastomeric core; a soft, elastomeric intermediate shell, which is produced in the presence of the core, typically via graft emulsion polymerization, and a hard, non-elastomeric outer shell, which is produced in the presence of the intermediate core-shell particles, typically via graft emulsion polymerization. Said multiphase alkyl (meth)acrylate emulsion polymers are referred to as core-shell-shell emulsion polymers in the following.

Preferably, the outer shell of the multiphase emulsion polymer is a hard phase comprising at least 70% by weight, more preferably at least 80% by weight, based on the outer shell, at least one C₁-C₆ alkyl methacrylate, preferably at least 70% by weight, more preferably at least 80% by weight, based on the outer shell, of methyl methacrylate.

Preferably, at least 50% by weight, more preferably at least 55% by weight, more preferably at least 80% by weight, based on the total weight of the emulsion polymer, of the outer layer is covalently bonded to the soft phase, i.e. soft core of core-shell emulsion polymer or intermediate shell of core-shell-shell emulsion polymer. Typically, the amount of covalently bonded outer layer (grafted polymer) (or also referred to as degree of grafting) is determined as being the amount insoluble in acetone.

In order to determine the degree of grafting the water of the emulsion polymer dispersion is removed in a drying cabinet resulting in a solid of pure modifier. 1.5 g of multiphase emulsion polymer is mixed with 40 g of acetone and stirred at 40° C. until a cloudy solution is obtained (2-3 h). The insoluble, grafted polymer is separated via centrifugation (e.g. 9000 rpm, 2-5 h) and the clear supernatant is dried to constant weight leading to the amount of the soluble fraction. Therewith, the degree of grafting is calculated applying formula (1).

$$Degree of grafting = 100 \% - acetone soluble content \qquad ( 1 )$$

Preferably, the degree of grafting of the emulsion polymer is in the range of 50 to 100%, preferably 52 to 99% by weight, based on the solid content of the emulsion polymer.

Preferably, the alkyl (meth)acrylate emulsion polymer comprises at least 60% by weight, preferably at least 75% by weight, based on the total emulsion polymer, of at least one C₁-C₂₀ alkyl (meth)acrylate, more preferably methyl methacrylate and/or n-butyl acrylate.

Generally, (meth)acrylates include C₁-C₁₀-alkyl (meth) acrylates, C₂-C₂₀-alkenyl (meth)acrylates, C₆-C₂₀ aryl (meth)acrylates, C₆-C₂₀ aralkyl (meth)acrylates, C₁-C₁₀ hydroxyalkyl (meth)acrylates, glycol di(meth)acrylates, and polyfunctional (meth)-acrylates.

Preferably the emulsion polymer comprises at least one C₁-C₁₀ alkyl methacrylate, preferably selected from methyl methacrylate, ethyl methacrylate, propyl methacrylate, isopropyl methacrylate, n-butyl methacrylate, isobutyl methacrylate, tert-butyl methacrylate, pentyl methacrylate, hexyl methacrylate, heptyl methacrylate, octyl methacrylate, isooctyl methacrylate and ethylhexyl methacrylate, and also cycloalkyl methacrylates, such as cyclohexyl methacrylate.

Preferably the emulsion polymer comprises at least one C₁-C₁₀ alkyl acrylate, preferably selected from methyl acrylate, ethyl acrylate, propyl acrylate, isopropyl acrylate, n-butyl acrylate, isobutyl acrylate, tert-butyl acrylate, pentyl acrylate, hexyl acrylate, heptyl acrylate, octyl acrylate, isooctyl acrylate and ethylhexyl acrylate, and also cycloalkyl acrylates, such as cyclohexyl acrylate.

Particularly, the multiphase alkyl (meth)acrylate emulsion polymer comprises (preferably consists of):
at least 10% by weight, preferably at least 20% by weight, preferably 10 to 70% by weight, of at least one C₁-C₁₀, preferably C₁-C₆ alkyl methacrylate, preferably methyl methacrylate;
5 to 80% by weight, preferably 20 to 80% by weight, of at least one C₁-C₁₀ alkyl acrylate (preferably n-butyl acrylate) or at least one conjugated diene (preferably butadiene);
0 to 2% by weight, preferably 0.1 to 2% by weight, more preferably 0.5 to 1% by weight, of at least one crosslinking monomer, preferably a polyfunctional (meth)acrylate and/or allyl (meth)acrylate; and
0 to 15% by weight, preferably 0.5 to 10% by weight, more preferably 0.5 to 5% by weight, of optionally further monomers, preferably different from the monomers mentioned above, for example vinyl aromatic monomers, e.g. styrene, α-methylstyrene or benzyl methacrylate, preferably styrene.

The amounts are given based on the total mass of monomers.

More particularly, the multiphase alkyl (meth)acrylate emulsion polymer comprises (preferably consists of):
at least 40% by weight, preferably 40 to 70% by weight, of at least one C₁-C₁₀, preferably C₁-C₆ alkyl methacrylate, preferably methyl methacrylate;
5 to 45% by weight, preferably 20 to 45% by weight, preferably 25 to 42% by weight, of at least one C₁-C₁₀ alkyl acrylate, preferably C₁-C₆ alkyl acrylate, preferably selected from ethyl acrylate, methyl acrylate, 2-ethylhexyl acrylate and butyl methacrylate, more preferably the C₁-C₁₀ alkyl acrylate includes n-butyl acrylate;
0 to 2% by weight, preferably 0.1 to 2% by weight, more preferably 0.5 to 1% by weight, of at least one crosslinking monomer, preferably a polyfunctional (meth)acrylate and/or allyl (meth)acrylate; and
0 to 15% by weight, preferably 0 to 12% by weight, more preferably 0.5 to 10% by weight, of optionally further monomers, preferably different from the monomers mentioned above, for example vinyl aromatic monomers, e.g. styrene, benzyl methacrylate.

The amounts are given based on the total mass of monomers.

It is preferred that the multiphase alkyl (meth)acrylate emulsion polymer comprises vinyl aromatic monomers, e.g. styrene and/or C₇-C₂₀ aralkyl (meth)acrylates, such as benzylmethacrylate, in order to adjust the differences of the refractive index of the hard and the soft phase. Styrenes which may be used are styrene, substituted styrenes with an alkyl substituent in the side chain, e.g. α-methylstyrene and α-ethylstyrene, substituted styrenes with an alkyl substituent on the ring, such as vinyltoluene and p-methylstyrene, and halogenated styrenes, such as monochlorostyrenes, dichlorostyrenes, tribromostyrenes and tetrabromostyrenes.

Typically, the crosslinking monomer has two or more polymerizable double bonds in the molecule. The crosslinking monomer may be selected from bifunctional (meth)acrylates, tri- or multifunctional (meth)acrylates, and other known crosslinkers, such as allyl methacrylate, allyl acrylate, and divinylbenzenes.

For example, bifunctional (meth) acrylates are di-esters of (meth)acrylic acid and a poly-functional alcohol, e.g. di(meth)acrylate of propane diol, butane diol, hexane diol, octane diol, nonane diol, decane diol, eicosane diol, ethylene glycol, diethylene glycol, triethylene glycol, tetraethylene glycol, dodecaethylene glycol, tetradecaethylene glycol, propylene glycol, dipropyl glycol, tetradecapropylene glycol. For example, tri- or multi-functional (meth) acrylates are tri- or multi-esters of (meth)acrylic acid and a poly-functional alcohol, e.g. trimethylolpropane tri(meth)acrylates and pentaerythritol tetra (meth)acrylate.

Suitable cross-linking monomers are for example describes in WO 02/20634 and EP 0 522 351.

Preferably, the alkyl (meth)acrylate emulsion polymer comprises at least one crosslinking monomer selected from ethylene glycol dimethacrylate, 1,4-butanediol dimethacrylate, divinylbenzene, and allyl (meth)acrylate. More preferably the crosslinking monomer is allyl methacrylate.

The alkyl (meth)acrylate emulsion polymer may comprise 0 to 15% by weight, preferably 0 to 10% by weight, more preferably 0.5 to 5% by weight, based on the solid content of the emulsion polymer, of further components, such as auxiliaries or residues of auxiliaries added during polymerisation and/or subsequent processing, for example emulsifiers, initiators, buffers or molecular weight regulators as mentioned below. In particular the alkyl (meth)acrylate emulsion polymer may comprise 0 to 15% by weight, preferably 0.001 to 10% by weight, more preferably 0.01 to 5% by weight, based on the solid content of the emulsion polymer, of molecular weight regulators, for example as described below.

### Core-Shell Emulsion Polymer

For example, the impact modifier is based on a two-phase emulsion polymer, which is composed of a soft, elastomeric core and a hard shell, for examples described in EP 0 528 196, DE 38 42 796, DE 10 2005 062 687. In particular said core-shell emulsion polymers are obtainable via a two-step emulsion polymerization in water for example as described in DE-A 38 42 796. The core particles are prepared via emulsion polymerization in a first step and the shell is prepared via emulsion polymerization of a monomer mixture in the presence of the core particles.

Typically, the hard phase has a glass transition temperature T_{g} above 70° C. and comprises from 80 to 100% by weight, based on the hard phase of methyl methacrylate. Typically, the soft core has a glass transition temperature T_{g} below −10° C. and comprises from 50 to 99.5% by weight, based on the soft core, of a C₁-C₁₀ alkyl acrylate and from 0.5 to 5% by weight of a crosslinking monomer. Further, the soft core may have a glass transition temperature T_{g} below −10° C. and may comprise from 50 to 100% by weight, based on the soft core, of at least one conjugated diene, e.g. butadiene.

In a preferred embodiment the multiphase alkyl (meth)acrylate emulsion polymer is a core-shell emulsion polymer comprising (preferably consisting of):
A1) 10 to 95% by weight, based on the total emulsion polymer, of a soft elastomeric core A1, having a glass transition temperature T_{g} below −10° C., which is built up from:
   A1.1) 50 to 99.5% by weight, based on A1, of at least one C₁-C₁₀ alkyl acrylate, preferably n-butyl acrylate;
   A1.2) 0.5 to 5% by weight, based on A1, of at least one crosslinking monomer, having two or more ethylenically unsaturated groups; and
   A1.3) 0 to 10% by weight, based on A1, of at least one further ethylenically unsaturated, free radically polymerizable monomer; and
B1) 5 to 90% by weight, based on the total emulsion polymer, of a hard shell B1, having a glass transition temperature T_{g} above 70° C., which is built up from:
   B11.1) 80 to 100% by weight, based on B1, of at least one C₁-C₈alkyl methacrylate, preferably methyl methacrylate, and
   B1.2) 0 to 20% by weight, based on B1, of at least one further ethylenically unsaturated, free radically polymerizable monomer, e.g. selected from C₁-C₆ alkyl acrylate, such as butyl acrylate or ethyl acrylate.

In another preferred embodiment the multiphase alkyl (meth)acrylate emulsion polymer is a core-shell emulsion polymer comprising (preferably consisting of):
A1) 50 to 90% by weight, based on the total emulsion polymer, of a soft elastomeric core A1, having a glass transition temperature T_{g} below −10° C., which is built up from:
   A1.1) 90 to 100% by weight, based on A1, of at least one conjugated diene, preferably butadiene;
   A1.2) 0 to 5% by weight, based on A1, of at least one crosslinking monomer, having two or more ethylenically unsaturated groups; and
   A1.3) 0 to 10% by weight, based on A1, of at least one further ethylenically unsaturated, free radically polymerizable monomer, e.g. at least one vinyl aromatic monomer, preferably styrene and/or α-methylstyrene; and
B1) 10 to 50% by weight, based on the total emulsion polymer, of a hard shell B1, having a glass transition temperature Tg above 70° C., which is built up from:
   B1.1) 70 to 90% by weight, based on B1, of at least one C₁-C₆ alkyl methacrylate, preferably methyl methacrylate, and
   B1.2) 10 to 30% by weight, based on B1, of at least one further ethylenically unsaturated, free radically polymerizable monomer, e.g. selected from vinyl aromatic monomers, preferably styrene and/or α-methylstyrene.

Preferably, the degree of grafting of the core-shell emulsion polymers is at least 50% by weight, preferably from 50 to 60% by weight, based on the total solid content of the emulsion polymer.

Generally, the glass transition temperature T_{g} of the polymer or the phases of the multiphase emulsion polymer can be determined in a known manner by differential scanning calorimetry (DSC). The glass transition temperature T_{g} may also be calculated as an approximation by means of the Fox equation.

### Core-Shell-Shell Emulsion Polymer

For example the impact modifier is based on a three phase emulsion polymer, which is composed of a hard core, that is for example build up from crosslinked methyl methacrylate, a soft intermediate shell, which is for example build up from crosslinked C₁-C₁₀ alkyl acrylate, preferably n-butyl acrylate; and a hard outer shell, that is for example built up from non-crosslinked methyl methacrylate. Typically, said core-shell-shell emulsion polymers are produced as described in EP 1 332 166 B1, WO 02/20634 and EP 0 522 351.

In particular the poly(alkyl)methacrylate impact modifier may comprise a methacrylate/butadiene/styrene copolymer or an acrylate/methacrylate copolymer.

In a preferred embodiment the multiphase alkyl (meth)acrylate emulsion polymer is a core-shell-shell emulsion polymer comprising (preferably consisting of)
A2) 5 to 40% by weight, based on the total emulsion polymer, of a hard, non-elastomeric core A2, having a glass transition temperature T_{g} above 50° C., which is built up from:
   A2.1) 80 to 100% by weight, based on A2, of at least one C₁-C₆ alkyl methacrylate, preferably of methyl methacrylate;
   A2.2) 0 to 20% by weight, based on A2, of at least one further ethylenically unsaturated, free radically polymerizable monomer; and
   A2.3) 0 to 5% by weight, based on A1, of at least one crosslinking monomer, having two or more ethylenically unsaturated groups;
B2) 20 to 75% by weight, based on the total emulsion polymer, of a soft elastomeric intermediate shell B2, having a glass transition temperature T_{g} below 0° C., which is built up from:
   B2.1) 45 to 99.5% by weight, based on B2, of at least one C₁-C₁₀ alkyl acrylate, preferably n-butyl acrylate;
   B2.2) 0.5 to 5% by weight, based on B2, of at least one crosslinking monomer, having two or more ethylenically unsaturated groups; and
   B2.3) 0 to 50% by weight, based on B2, of at least one further ethylenically unsaturated, free radically polymerizable monomer, preferably a monomer having an aromatic group; and
C2) 15 to 60% by weight, based on the total emulsion polymer, of a hard outer shell C2, having a glass transition temperature T_{g} above 50° C., which is built up from:
   C2.1) 80 to 100% by weight, preferably 90 to 100% by weight, based on C2, of at least one C₁-C₆ alkyl methacrylate, preferably methyl methacrylate; and
   C2.2) 0 to 20% by weight, preferably 0 to 10% by weight, based on C2, of at least one further ethylenically unsaturated free radically polymerizable monomer.

Preferably, at least 15% by weight, more preferably at least 25% by weight of the hard outer shell C2 are covalently bonded to the soft elastomeric intermediate shell B2.

Preferably, the degree of grafting of the core-shell-shell emulsion polymers is at least 50% by weight, preferably from 70 to 99% by weight, based on the total solid content of emulsion polymer.

### Method for Producing the Poly(Meth)Acrylate Impact Modifier

Further, the present invention is directed to a method for producing the inventive poly(meth)acrylate impact modifier comprising at least one multiphase alkyl (meth)acrylate emulsion polymer, encompassing the following steps:
(i) preparation of at least one multiphase alkyl (meth)acrylate emulsion polymer via emulsion polymerization, in particular via sequentially emulsion polymerization, wherein the multiphase alkyl (meth)acrylate emulsion polymer is obtained in form of a latex;
(ii) coagulation and dewatering, preferably mechanical dewatering, of the latex obtained in step (i), wherein the coagulation is carried out by means of physical coagulation, wherein a dewatered alkyl (meth)acrylate emulsion polymer is obtained, and wherein the dewatered alkyl (meth)acrylate emulsion polymer comprises less than or equal to 3.0 mmol/kg, preferably less than or equal to 2.5 mmol/kg, based on the solid content of the alkyl (meth)acrylate emulsion polymer, of alkali metal ions, and wherein the molar ratio of alkali ions to multivalent metal ions in the dewatered alkyl (meth)acrylate emulsion polymer, is less than or equal to 1.3, preferably less than or equal to 1.2,
wherein a coagulant comprising at least one salt of a multivalent metal ion, preferably selected from alkaline earth metals, zinc and aluminium, is added to the emulsion polymer before and/or during coagulation.

The preferred embodiments as described above in connection with the inventive impact modifier apply to the inventive process accordingly.

In particular the poly(meth)acrylate impact modifier comprising or preferably essentially consisting of the multiphase alkyl (meth)acrylate emulsion polymer can be obtained as dried polymer powder, in particular after dewatering and drying.

In particular the poly(meth)acrylate impact modifier comprising or preferably essentially consisting of the multiphase alkyl (meth)acrylate emulsion polymer can be obtained in form of a polymer granulate. For example, the polymer powder obtained after drying may be granulated, optionally under addition of one or more additives and/or of one or more additional polymeric components, e.g. by means of a commonly known melt extrusion process. Further, it is possible that the impact modifier is obtained in form of a polymer granulate, wherein coagulation and dewatering in step ii) is carried out by means of thermal shear coagulation in an extruder.

In a preferred embodiment the coagulation is carried out by means of freeze coagulation, wherein the aqueous phase of the coagulated emulsion polymer is at least partially removed via mechanical dewatering, for example in a centrifugation step. Typically, the water content of said dewatered emulsion polymer is in the range of 5 to 40% by weight, preferably 7 to 30% by weight, based on the dewatered emulsion polymer. In a preferred embodiment the coagulation and dewatering in step (ii) is carried out as described in WO 2015/074883.

Preferably, step (ii) may encompass a sintering step as described below. Further, the inventive method may encompass one or more washing steps (iii) and/or one or more drying steps (iv) as described below.

In a preferred embodiment the coagulation and dewatering in step ii) is carried out via extrusion. Typically, the latex obtained by emulsion polymerization is introduced into an extruder, which typically comprises a coagulation zone, a dewatering zone and a devolatilization zone. Preferably, the coagulation and dewatering via extrusion can be carried out as described in WO 02/18453, EP0683028 or EP 0187715.

In another preferred embodiment the coagulation and dewatering in step ii) is carried out via freeze coagulation. Preferably, the coagulation and dewatering via freeze coagulation can be carried out as described in WO 2015/074883.

### Emulsion Polymerization (Step (i))

The inventive method encompasses the emulsion polymerization step (i), wherein at least one multiphase alkyl (meth)acrylate polymer is prepared via emulsion polymerization, in particular via sequentially emulsion polymerization, and the multiphase alkyl (meth)acrylate emulsion polymer is obtained in form of a latex.

The multiphase emulsion polymer is prepared in an aqueous phase in the usual way by two, three or multi-stage emulsion polymerization. Typically, the stages of emulsion polymerization are carried out at a temperature in the range of 20 to 100° C., preferably of 60 to 90° C.

Generally, the core is created via emulsion polymerization in the first stage. Typically, the core has an average particle size from 50 to 150 nanometres (nm) for core-shell-emulsion polymers, and from 100 to 300 nanometres (nm) for core-shell-shell emulsion polymers. Methods for adjusting the desired particle size are known to the skilled person. Advantageously, control of particle size is carried out according to the seed latex method, for example described in US 2007/0123610 A1 and WO 2004/056893.

In case of core-shell emulsion polymers, the hard, outer phase is prepared in the second polymerization stage in the presence of the soft core after conclusion of the first polymerization stage.

In case of core-shell-shell emulsion polymers, the elastomer intermediate phase is prepared in the second polymerization stage in the presence of the core after conclusion of the first polymerization stage. Finally, in the third stage, after the second polymerization stage is concluded, the final rigid phase is created in the same way in the presence of the emulsion polymer of the second stage.

The emulsion polymerization is suitably carried out in the presence of anionic emulsifiers. Commonly known anionic emulsifiers are for example alkyl sulfates, alkylsulfonates, alkyl sulfonic acids, aralkylsulfonates, soaps of saturated or unsaturated fatty acids. Preferably an anionic emulsifier, selected from sulfonates, alkyl sulfosuccinates, and alkoxylated and sulfated paraffins, and mixtures thereof, is used.

Preferably, the emulsion polymer latex is polymerized by aqueous free-radical emulsion polymerization. The reaction is typically initiated via water-soluble or oil-soluble free-radical polymerization initiators.

For example suitable polymerization initiators are selected from inorganic or organic peroxides, such as dilauroyl peroxide, tert-butyl peroctoate, tert-butyl perisononanoate, dicyclohexyl peroxidicarbonate, dibenzoyl peroxide and 2,2-bis(tert-butylperoxy)butane; azo compounds, such as 2,2′-azobis(isobutyronitrile) and 2,2′-azobis(2,4-di-methylvaleronitrile), and redox initiator systems. Examples of suitable redox systems are combinations of tertiary amines with peroxides or sodium disulphite and persulfates of potassium, sodium or ammonium or preferably peroxides.

Also preferred is to carry out the polymerization with a mixture of various polymerization initiators of differing half-life times, for example dilauroyl peroxide and 2,2-bis(tert-butylperoxy)butane, in order to hold the flow of free radicals constant during the course of the polymerization or else at various polymerization temperatures.

The polymerization initiator is typically used in an amount of from 0.01 to 2% by weight, based on the monomer mixture. Typically, the polymerization initiator is used in the range of 0.01 to 0.5% by weight, based on the aqueous emulsion polymerization mixture.

Preferably alkali metal peroxidisulfates or ammonium peroxidisulfates are used as polymerization initiators, for example from 0.01 to 0.5% by weight, based on the aqueous phase of polymerization mixture, wherein the polymerization is preferably initiated at temperatures from 20° C. to 100° C. Preferably redox systems are used as polymerization initiators, for example from 0.01 to 0.05% by weight of organic hydroperoxides and 0.05 to 0.15% by weight of sodium hydroxymethylsulfinate (e.g. Rongalite®), each based on the aqueous phase of polymerization mixture, wherein the polymerization is preferably initiated at a temperature in the range of from 20° C. to 80° C.

The chain lengths of the polymers, in particular in the outer hard phase, may be adjusted by polymerizing the monomer mixture in the presence of molecular weight regulators. In particular known mercaptans can be used for this purpose, such as n-butyl mercaptan, n-dodecyl mercaptan, 2-mercaptoethanol or 2-ethylhexyl thioglycolate or pentaerythritol tetrathioglycolate. Typically, the amount of molecular weight regulator is from 0.05 to 5% by weight, based on the monomer mixture, preferably from 0.1 to 2% by weight and particularly preferably from 0.2 to 1% by weight, based on the monomer mixture. Preferably, n-dodecyl mercaptan is used as molecular weight regulator.

It is moreover possible to use salts, acids and bases in the emulsion polymerization, in particular to adjust the pH or to buffer the reaction mixture. For example, sulfuric acid, phosphoric acid, solutions of sodium hydroxide, potassium hydroxide, sodium salts and potassium salts of carbonates, bicarbonates, sulfates and/or phosphates (e.g. tetrasodium pyrophosphate) can be used. Typically, the emulsion polymer latex obtained in step (i) has a pH value in the range of 2 to 7, preferably 2.5 to 6.

Typically, the emulsion polymer latex obtained in step (i) has a solid content in the range of 20 to 60% by weight, based on the total weight of emulsion polymer latex. If necessary, the solid content can be adjusted.

Coagulation and Mechanical Dewatering (Step (ii))

The inventive method encompasses the coagulation and dewatering, preferably mechanical dewatering, in step (ii), wherein the latex obtained in step (i) is coagulated by means of physical coagulation, preferably selected from shear coagulation, thermal shear coagulation, spray drying, freeze coagulation and pressure coagulation, more preferably by means of freeze coagulation, shear coagulation or thermal shear coagulation, and wherein a dewatered alkyl (meth)acrylate emulsion polymer is obtained, comprising less than or equal to 3.0 mmol/kg, preferably less than or equal to 2.5 mmol/kg, based on the solid content of the alkyl (meth)acrylate emulsion polymer, of alkali metal ions, and wherein the molar ratio of alkali ions to multivalent metal ions in the dewatered alkyl (meth)acrylate emulsion polymer, is less than or equal to 1.3, preferably less than or equal to 1.2.

According to the present invention “coagulation by physical means” or “physical coagulation” means agglomeration and precipitation of the polymer particles in the emulsion polymer latex by applying a physical process, wherein typically the repulsive forces between the polymer particles, that effect the separation and stabilisation of the polymer particles in the latex, are reduced. Typically, “chemical coagulation” means agglomeration and precipitation of the polymer particles in the emulsion polymer latex by adding a chemical agent (coagulant), that typically effects partly or wholly neutralization of stabilizing charges located at the polymer particles.

According to the inventive method for producing the poly(meth)acrylate impact modifier the coagulation is carried out by means of physical coagulation in combination with the addition of a coagulant before and/or during coagulation (i.e. carried out by a combination of physical and chemical coagulation).

The physical coagulation of the emulsion polymer latex may be carried out by spray drying, coagulation by freezing (e.g. described in WO 2015/07488), or by mechanical and/or thermal stressing, in particular using a degassing extruder (e.g. described in WO 2002/18453, EP-A 0 979 162, EP-A 0 683 028).

According to the invention a coagulant comprising at least one salt of a multivalent metal ion, preferably selected from alkaline earth metals, zinc and aluminium, more preferably selected from magnesium, calcium and aluminium, is added to the emulsion polymer before and/or during coagulation. In a preferred embodiment at least one calcium salt is added as coagulant. Preferably, the coagulant is an aqueous solution of at least one salt of a multivalent metal ion, preferably selected from alkaline earth metals, zinc and aluminium, more preferably selected from magnesium, calcium and aluminium. Typically, said aqueous solution comprises from 2 to 30% by weight, preferably from 5 to 25% by weight, of said at least one salt of a multivalent metal ion. Preferably, the aqueous solution of the at least one salt of a multivalent metal ion is a real, clear solution, wherein the whole amount of the multivalent metal ion is in solvated form.

Typically, the coagulant is an aqueous solution of at least one salt of a multivalent metal ion, having a good solubility in water. Preferably, the salt of the multivalent metal ion should have a solubility in water (e.g. at a temperature of 20 to 25° C., preferably at room temperature, 23° C.) of 0.1 mol/I or more, preferably 0.5 mol/I or more, more preferably 1.0 mol/I or more, also preferably 3.0 mol/I or more. In particular the salt of multivalent metal ion is selected from water-soluble acetates, chlorides, hydroxides and/or sulfates, wherein water-soluble refers to a solubility in water of at least 0.1 mol/l, preferably at least 1.0 mol/l, at room temperature, 23° C. For example, an aqueous solution of calcium acetate, calcium chloride, calcium hydroxide, magnesium sulfate, magnesium chloride, aluminium sulfate or mixtures thereof can be used as coagulant.

In particular, the coagulant is selected so that the formation of less water-soluble metal salts or water-insoluble salts in the coagulation mixture is avoided.

Typically, the pH value of the coagulation mixture during the coagulation step is in the range of 2 to 7, preferably 2.5 to 6.

Typically, the at least one salt of a multivalent metal ion, preferably selected from alkaline earth metals, zinc and aluminium, is added in a range from 0.01 to 10% by weight, preferably 0.02 to 5% by weight, more preferably 0.03 to 3% by weight, based on solid content of the polymer dispersion. Particularly, the at least one salt of a multivalent metal ion is added in a range of from 0.01 to 2 molar, based on the molar amount of the sum of alkali metal ions in the emulsion polymer latex obtained in step (i). For example, 0.01 to 2 mol alkaline earth metal ions based 1 mol of alkali metal ions are added to the emulsion polymer latex.

In particular the at least one salt of a multivalent metal ion is selected from metal halogenides, such as chlorides, metal sulfates, metal phosphates, such as orthophosphates or pyrophosphates, metal hydroxides, organic acid metal salts, e.g. metal acetates, metal oxalates, metal citrates and metal formats. Preferably the at least one salt of a multivalent metal ion is selected from chlorides, sulfates and acetates. Furthermore, typically known hydrates of said salts can be utilized.

For example, suitable alkaline earth metal salts here are magnesium sulfate (such as kieserite (Mg[SO₄]·H₂O), pentahydrite (Mg[SO₄ ]·5H₂O), hexahydrite (Mg[SO₄ ]·6H₂O), and epsomite (Mg[SO₄ ]·7H₂O, Epsom salt)), magnesium chloride, calcium chloride, calcium hydroxide, calcium acetate, calcium formate, magnesium formate or mixtures thereof. The use of calcium acetate is particular preferred.

For example, suitable aluminium salts are aluminium sulfate (Al₂(SO₄)₃), aluminium sulfate hydrates, aluminium chloride (AlCl₃), aluminium chloride hydrates, aluminium chlorohydrate, and polyaluminium chloride.

For example, suitable zinc salts are zinc chloride (ZnCl₂), zinc sulfate (ZnSO₄), zinc sulfate hydrates (e.g. ZnSO₄·7 H₂O) and zinc oxalate.

It is also possible to use a mixture of two or more salts of a multivalent metal ion as mentioned above. For example, it is possible to use a combination of at least alkaline earth metal salt and at least one aluminium salt.

Typically, the coagulation can be carried out in a temperature range from 20 to 100° C.; preferably from 30 to 80° C.

Dewatering of the coagulated latex can be carried out via mechanical dewatering (for example centrifugation and/or filtration) and/or via thermally dewatering (for example by evaporation of the aqueous phase of the emulsion polymer, e.g via spray drying). Further, it is possible to carry out the coagulation and dewatering of the emulsion polymer latex in one step, e.g. in case of spray drying or in case of coagulation and dewatering in a degassing extruder.

Preferably, dewatering of the coagulated emulsion polymer is carried out via mechanical dewatering, for example by means of centrifugation, decantation, or filtration. Preferably, the coagulated emulsion polymer is dewatered by means of batch-wise or continuously centrifugation. The coagulated emulsion polymer is typically centrifuged for a period of from 90 seconds to 10 minutes.

According to another embodiment of the invention the dewatering of the coagulated emulsion polymer is carried out by means of a degassing extruder, in particular in at least one dewatering zone of the extruder used for shear coagulation or thermal shear coagulation of the emulsion polymer.

Typically, the dewatered emulsion polymer obtained in step (ii) has a water content of less than or equal to 40% by weight, preferably in the range of 2 to 35% by weight, more preferably of 5 to 20% by weight.

The water content (also termed residual moisture content) of the multistage emulsion polymer after dewatering is the content of water in percent by weight, based on the moist polymer obtained after dewatering. The water content is in particular determined with the aid of suitable analysis equipment (e.g. drying and weighing devices), where the sample is dried until constant weight of the sample is achieved over a defined period. By way of example, the water content of the emulsion polymer can be determined in a moisture analyser, wherein the sample is dried at a temperature in the range of 80 to 180° C. In particular the water content may be determined using a Halogen Moisture Analyzer from Mettler Toledo at 160° C. until constant weight has been achieved for 30 seconds.

Preferably, the dewatered alkyl (meth)acrylate emulsion polymer obtained in dewatering step (ii) or after optionally washing step (iii) comprises from 0 to 3.0 mmol/kg, preferably from 0 to 2.5 mmol/kg, also preferably from 0.0 to 2.0 mmol/kg, particularly preferred from 0.01 to 3 mmol/kg, based on the solid content of the emulsion polymer, of alkali metal ions (e.g. sodium and/or potassium), and from 0.5 to 20.0 mmol/kg, preferably from 2.0 to 10.0 mmol/kg, more preferably from 2.0 to 8.0 mmol/kg, based on the solid content of the emulsion polymer, of multivalent metal ions, preferably selected from alkaline earth metals (e.g. magnesium and/or calcium), zinc and aluminium.

### Optional Sintering

In particular, step (ii) of the inventive process encompasses a sintering step after coagulation and before dewatering of the emulsion polymer.

Preferably, step (ii) may encompass a sintering step, wherein the coagulated multistage alkyl (meth)acrylate emulsion polymer can be maintained at a sintering temperature (Tₛ) near or below the glass transition temperature T_{g} of the outer phase/outer shell of the multistage alkyl (meth)acrylate emulsion polymer. Preferably, the optional sintering step is carried out after coagulation and before dewatering. In particular, the optional sintering step is carried out at a temperature Tₛ≥T_{g}−50 K, preferably Tₛ≥T_{g}−30 K, more preferably T_{g}−15 K≤Tₛ≤T_{g}+5 K.

Preferably, the coagulation mixture is kept at a temperature (sintering temperature) in the range of 60° C. to 140° C., preferably 70° C. to 135° C., more preferably 75° C. to 130° C. after coagulation of the emulsion polymer. In particular the coagulated emulsion polymer is kept at said sintering temperature T₂ for a period of 2 minutes to 24 hours, preferably 2 to 15 minutes, preferably 3 to 10 minutes, more preferably 5 to 10 minutes.

In a preferred embodiment the coagulated emulsion polymer may be treated with steam after coagulation during sintering step.

The method for producing the poly(meth)acrylate impact modifier may comprise one or both of the optional steps:
(iii) optionally washing of the dewatered alkyl (meth)acrylate emulsion polymer;
(iv) optionally drying of the dewatered alkyl (meth)acrylate emulsion polymer obtained in step ii) or iii).
   Optional Washing Step (iii)

In a preferred embodiment, the mechanical dewatering of the emulsion polymer in step (ii) is followed by a washing step (iii), where the dewatered emulsion polymer is preferably treated with water or with a mixture of water and a polar, water-miscible organic solvent. The water or the mixture is preferably removed by filtration or centrifugation after the treatment. Preferably, in a downstream washing step (iii) the emulsion polymer is obtained with water content of less than or equal to 40% by weight, preferably in the range of 2 to 35% by weight, more preferably of 5 to 20% by weight.

For example, the washing step (iii) can be carried out by addition of water or a mixture of water and a polar, water-miscible organic solvent during the centrifugation, in particular in a continuous centrifugation process.

Preferably, the dewatered emulsion polymer obtained after an optional washing step (iii) exhibits the amounts of alkali metal ions and of multivalent metal ions, such as alkaline earth metal ions, zinc ions or aluminium ions, as described above for the dewatered emulsion polymer obtained after step (ii).

### Optional Drying Step (iv)

The inventive method for producing the poly(meth)acrylate impact modifier may encompass one or more optional drying steps (iv).

For example, the dewatered emulsion polymer can be dried by hot drying gas, e.g. air, or by means of a pneumatic dryer. Drying can for example be carried out in a cabinet dryer or other commonly known drying apparatus, such as flash dryer or fluidized bed dryer. Typically, the optional drying step (iv) is carried out at a temperature in the range of 50 to 160° C., preferably from 55 to 155° C., particularly preferably from 60 to 150° C.

In another embodiment the coagulated and dewatered emulsion polymer is dried within a degassing extruder, in particular in an additional degassing sections of an extruder used for coagulation and dewatering.

Typically, the dried emulsion polymer obtained has a water content below 5%, preferably below 2%, preferably in the range from 0.05 to 2% by weight, preferably from 0.1 to 1.5% by weight, particularly preferably from 0.1 to 1% by weight.

Preferably, the dried emulsion polymer, for example obtained as powder or granulate, exhibit the same amounts of alkali metal ions and of multivalent metal ions, such as alkaline earth metal ions, zins ions and aluminium ions, as the dewatered and optionally washed emulsion polymer obtained after step (ii) or (iii).

In a preferred embodiment of the invention in step (ii) the coagulation is carried out by means of freeze-coagulation and the mechanical dewatering of the coagulated emulsion polymer is carried out by means of centrifugation, wherein the water content of the dewatered emulsion polymer is less than or equal to 40% by weight, based on the dewatered emulsion polymer, and wherein the method comprises
(iii) optionally washing the dewatered alkyl (meth)acrylate emulsion polymer;
(iv) drying the dewatered alkyl (meth)acrylate emulsion polymer obtained in step ii) or iii), wherein the poly(meth)acrylate impact modifier is obtained as a polymer powder.

In another preferred embodiment of the invention in step (ii) the coagulation and the mechanical dewatering is carried out by means of thermal shear coagulation, wherein the latex obtained in step (i) is introduced into an extruder line, which comprises at least one coagulation zone, at least one dewatering zone and at least one degassing zone, wherein the poly(meth)acrylate impact modifier is obtained as a polymer granulate.

### Optional Ion Exchange Step

The inventive method for producing the impact modifier can preferably comprise at least one ion exchange step, wherein the latex obtained in step (i) is brought in contact with an ion exchange material. Preferably, the latex shows no coagulation in the optional ion exchange step and the latex obtained in the optional ion exchange step is processed in the following coagulation step (ii) as described above.

Generally, the ion exchange material may be at least one cation exchange material (i.e. material encompassing anionic groups, that can be loaded with protons H+) and/or at least one anion exchange material (i.e. material encompassing cationic basic groups). Different ion exchange materials may be used as mixture in one contacting step with the emulsion polymer latex and/or successively in two or more contacting steps with the emulsion polymer latex. For example, it is possible to contact the latex obtained in step (i) with an anion exchange material in a first step and to contact the latex with a cation exchange material in a second step afterwards. Furthermore, the use of mixed ion exchange materials, comprising anion and cation exchange groups, is possible.

Preferably, at least one cation exchange material is used, in order to reduce the amount of alkali metal ions before coagulation in step (ii). In a preferred embodiment, the latex obtained in step (i) is brought in contact with at least one cation exchange material, more preferably a strong acid cation exchange material, particularly in protonated form (H-form), in step (ii). Suitable cation exchange materials comprise at least one acidic group, such as carboxylic acid groups (—COOH) or sulfonic acid groups (—S(═O)₂OH), preferably strong acid groups, such as sulfonic acid groups. In case that the cation exchange material is not in the protonated form, e.g. in Na-form, the cation exchange material can be treated with an aqueous acid solution, such as hydrochloric acid or sulfuric acid, in order to obtain the protonated H-form of the exchange material. Suitable examples of commercially available cation exchange materials are ion exchange resins manufactured by Dow Chemical Co. under the tradenames/trademarks DOWEX® MARATHON C, DOWEX® MONOSPHERE C-350, DOWEX® HCR-S/S, DOWEX® MARATHON MSC, DOWEX® MONOSPHERE 650C, DOWEX® HCR-W2, DOWEX® MSC-1, DOWEX® HGR NG (H), DOWEX® DR-G8, DOWEX® 88, DOWEX® MONOSPHERE 88, DOWEX® MONOSPHERE C-600 B, DOWEX® MONOSPHERE M-31, DOWEX® MONOSPHERE DR-2030, DOWEX® M-31, DOWEX® G-26 (H), DOWEX® 50W-X4, DOWEX® 50W-X8, DOWEX® 66; ion exchange resins manufactured by Rohm and Haas, under the tradenames/trademarks Amberlyst® 131, Amberlyst® 15, Amberlyst® 16, Amberlyst® 31, Amberlyst® 33, Amberlyst® 35, Amberlyst® 36, Amberlyst® 39, Amberlyst® 40 Amberlyst® 70, Amberlite® FPC11, Amberlite® FPC22, Amberlite® FPC23; ion exchange resins manufactured by Brotech Corp., under the tradenames/trademarks Purofine® PFC150, Purolite® C145, Purolite® C150, Purolite® C160, Purofine® PFC100, Purolite® C100; and ion exchange resins manufactured by Thermax Limited Corp., under the tradename/trademark Monoplus™ S100 and Tulsion® T42. Other acidic cation exchange resins known to those skilled in the art may also be used. Preferably, Dowex® Marathon C, from Dow Chemical is used.

The latex obtained in step (i) can be brought in contact with the at least one ion exchange material in any suitable way. For example, the ion exchanging step can be carried out by dispersion of the ion exchange material in the latex or in a column ion exchange step.

Furthermore, the inventive method may comprise the optional step of
(v) adding one or more additives to the multiphase alkyl (meth)acrylate emulsion polymer.

Appropriate conventional additives can be admixed in each stage of the inventive method for producing the poly(meth)acrylate impact modifier, e.g. before or during dewatering of the coagulated emulsion polymer. Among them are dyes, pigments, stabilizers, lubricants, UV-protective agents, etc.

The optional additive may be selected from commonly known additives and/or auxiliaries for plastic materials. With respect to conventional auxiliaries and additives, reference is made by way of example to “Plastics Additives Handbook”, Hans Zweifel 6th Edition, Hanser Publ., Munich, 2009. For example, the at least one additive may be selected from fillers, reinforcing agents, dyes, pigments, lubricants or mould-release agents, stabilizers, in particular light and heat stabilizers, antioxidants, UV absorbers, plasticizers, impact modifiers, antistatic agents, flame retardants, bactericides, fungicides, optical brighteners, and blowing agents.

For example, the impact modifier may comprise 0 to 15% by weight, preferably 0 to 10% by weight, more preferably 0.5 to 5% by weight, based on the solid content of impact modifier, of at least one additive as mentioned above.

### Thermoplastic Moulding Composition and Method for its Production

In another aspect the present invention is directed to a thermoplastic moulding composition (also referred to as moulding composition in the following) comprising the inventive poly(meth)acrylate impact modifier and optionally at least one resin based on thermoplastic (meth)acrylate polymers. For example, such impact-modified poly(meth)acrylate moulding compositions are described in WO 2004/056893.

In particular, the thermoplastic moulding composition comprises (preferably consists of):
1 to 100% by weight, preferably 5 to 100% by weight, based on the total moulding composition, of at least one poly(meth)acrylate impact modifier as described above;
0 to 99% by weight, preferably 0 to 95% by weight, based on the total moulding composition, of at least one thermoplastic (meth)acrylate polymer, preferably poly(methyl methacrylate), and
0 to 50% by weight, preferably 0 to 10% by weight, based on the total moulding composition, 0 to 10% by weight, based on the total moulding composition, of one or more additive, preferably two or more additives, for example selected from UV absorbers, UV stabilizers, heat stabilizers, antioxidants, lubricants, dyes, and processing agents; and/or one or more additional polymeric component.

Typically, the thermoplastic (meth)acrylate polymer here preferably comprises (preferably consist of), based in each case on its total weight,
from 50.0 to 100.0% by weight, preferably from 60.0 to 100.0% by weight, particularly preferably from 75.0 to 100.0% by weight, in particular from 85.0 to 99.5% by weight, of alkyl methacrylate monomers (respectively repeat units) having from 1 to 20, preferably from 1 to 12, more preferably from 1 to 8, in particular from 1 to 4, carbon atoms in the alkyl radical,
from 0.0 to 40.0% by weight, preferably from 0.0 to 25.0% by weight, in particular from 0.1 to 15.0% by weight, of alkyl acrylate monomers (respectively repeat units) having from 1 to 20, preferably from 1 to 12, advantageously from 1 to 8, in particular from 1 to 4, carbon atoms in the alkyl radical, and
from 0.0 to 30% by weight, preferably 0.0 to 8.0% by weight of styrenic monomers (respectively repeat units).

Particularly, the thermoplastic (meth)acrylate polymer comprises, based on its total weight, at least 50.0% by weight, advantageously at least 60.0% by weight, preferably at least 75.0% by weight, in particular at least 85.0% by weight of methyl methacrylate.

For example, the moulding composition may comprise one or more additive and/or one or more additional polymeric component selected from dyes, pigments and cross-linked polymer beads.

In a preferred embodiment the inventive thermoplastic moulding composition as described above comprises up to 50% by weight, preferably 0.0001% to 50% by weight, based on the total thermoplastic moulding composition, of at least one dye and/or pigment, for example selected from perinone dyes, quinophthalone dyes, anthraquinone dyes, azo dyes, inorganic pigments, phtalocyanine pigments, and carbon black.

Further, the inventive thermoplastic moulding composition as described above may comprise 0.01% to 50% by weight, based on the total thermoplastic moulding composition, of at least one cross-linked polymer beads, preferably selected from cross-linked polymer beads (scattering beads) having a different refractive index compared to the refractive index of the polymer matrix formed by thermoplastic moulding composition. Suitable cross-linked polymer beads are described below.

Typically, the thermoplastic (meth)acrylate polymer has a number-average molar mass in the range from 1000 to 100 000 000 g/mol, preferably in the range from 10 000 to 1 000 000 g/mol, in particular in the range from 50 000 to 500 000 g/mol. This molar mass may be determined by gel permeation chromatography, for example, with calibration based on polymethylmethacrylat.

Furthermore, the invention is directed to a method for producing the thermoplastic moulding composition, wherein the components, typically in the form of their melts or in the form of powders or pellets, are mixed and homogenized, for example in a single screw or multi screw extruder or on a roll mill.

In particular the method for producing the thermoplastic moulding composition comprises:
xi) mixing 5 to 100% by weight, based on the total moulding composition, of at least one inventive poly(meth)acrylate impact modifier as described above; 0 to 95% by weight, based on the total moulding composition, of at least one thermoplastic (meth)acrylate polymer; and optionally 0 to 10% by weight, of one more additive and/or one or more additional polymeric component; and
xii) melt compounding of the mixture obtained in step xi), preferably at a temperature in the range of 200 to 280° C.

Conventional additives may be admixed at any processing stage suitable for this purpose. These include dyes, pigments, fillers, reinforcing fibres, lubricants, UV stabilizers, organic or inorganic scattering particles etc.

Further, the present invention is directed to moulded articles or semi-finished products, such as foils, films or sheets, produced from the thermoplastic moulding composition as described above.

The thermoplastic moulding compositions can be used for the production of moulded articles of any type, and semi-finished products, such as sheets, films, fibres foams etc. Processing may be carried out using the known processes for thermoplastic processing, in particular production may be effected by thermoforming, (co)-extruding, injection moulding, calendaring, blow moulding, compression moulding, press sintering, deep drawing or sintering, preferably by injection moulding.

### Moulded Article or Semi-Finished Product

The present invention is also directed to a moulded article or semi-finished product produced from the inventive thermoplastic moulding composition as described above.

For example, the moulded article or semi-finished product may comprise the inventive thermoplastic moulding composition as described above and additionally one or more additive as described above and/or one or more additional polymeric component, for example the additive may be selected from dyes, pigments and cross-linked polymer beads.

Preferably, the moulded article or semi-finished product comprises up to 50% by weight, preferably 0.0001% to 50% by weight, based on the total moulded article or semi-finished product, of at least one additive, preferably selected from dyes, pigments, organic scattering particles (in particular cross-linked polymer beads as described below) and inorganic scattering particles.

Preferably, the moulded article or semi-finished product comprises up to 50% by weight, preferably 0.0001% to 50% by weight, based on the total moulded article or semi-finished product, of at least one dye and/or pigment, preferably selected from perinone dyes, quinophthalone dyes, anthraquinone dyes, azo dyes, inorganic pigments, phtalocyanine pigments, and carbon black.

Preferably, the moulded article or semi-finished product comprises 0.01% to 50% by weight, based on the total moulded article or semi-finished product, of at least one organic or inorganic scattering particles, preferably selected from cross-linked polymer beads, more preferably selected from cross-linked polymer beads (scattering beads) having a different refractive index compared to the refractive index of the polymer matrix formed by thermoplastic moulding composition.

In a preferred embodiment the semi-finished product is a film or sheet.

In a preferred embodiment the moulded article or semi-finished product is transparent. In particular the moulded article or semi-finished product has a haze value of less than or equal to 30.0%, preferably of less than or equal to 20.0%, more preferably of less than or equal to 10%, in particular of less than or equal to 6.0%, measured by means of a BYK Gardner Hazegard-plus hazemeter in accordance with ASTM D1003-13 for material thicknesses of 40 μm-1000 μm determined after water storage at 80° C. for 4 h-24 h. In particular the moulded article or semi-finished product has a haze value, determined after water storage at 80° C. for 24 h according to ASTM D1003-13, of less than or equal to 30%, preferably less than or equal to 25.0%, more preferably less than or equal to 20.0% for material thicknesses of 1 mm.

In particular the moulded article or semi-finished product is produced by providing the thermoplastic moulding composition as described above and adding at least one additive; in particular selected from dyes, pigments and cross-linked polymer beads as described above, and mixing the thermoplastic moulding composition and the art least one additive, preferably via melt compounding, e.g. during film formation process or injection moulding process.

Typically, said dye and/or pigment can be added to the inventive thermoplastic moulding composition as described above in form of a colouring preparation, a liquid composition or masterbatch comprising said colouring preparation.

In some embodiments of the present invention, the moulding composition may comprise organic or inorganic scattering particles dispersed in the matrix of the polymer. The low haze value after hot water storage of the inventive impact-modified thermoplastic moulding compositions may be advantageous in combination with scattering particles as well, because a more homogenous opaque and matt appearance, even after hot water storage, can be obtained. Although the choice of the scattering particles is not particularly limited, they are typically selected in such a way that the refractive index of the scattering particles differs from that of the copolymer matrix by at least 0.01. The refractive index can be measured at the Na D-line at 589 nm at 23° C. as specified in the standard ISO 489 (1999).

The scattering particles usually have an average particle diameter of from 0.01 μm to 100.0 μm. The average particle diameter—indicated as so-called volume averaged d₅₀-value (that is 50 percent by volume of the particles have a particle size below the specified average particle size) of the scattering particles can be measured in accordance with the standard for laser diffraction measurements ISO 13320-1 (2009). Typically, the size of the scattering particles is determined by laser light scattering, e.g. at room temperature, 23° C., using Beckman Coulter LS 13 320 laser diffraction particle size analyser.

Inorganic scattering particles may include traditional inorganic opacifiers, e.g. barium sulphate, calcium carbonate, titanium dioxide or zinc oxide.

Organic scattering particles are typically spherical scattering beads consisting of a cross-linked polymeric material such as poly alkyl(meth) acrylates, silicones, polystyrenes etc. Preferably, at least 70%, particularly at least 90%, of scattering beads, based on the number of scattering beads, are spherical.

Preferred scattering beads composed of crosslinked polystyrenes are commercially available from Sekisui Plastics Co., Ltd. with the trademarks Techpolymer® SBX-4, Techpolymer® SBX-6, Techpolymer® SBX-8 and Techpolymer® SBX-12.

Other particularly preferred spherical plastics particles which are used as scattering agents comprise cross-linked silicones. Silicone scattering agents particularly preferably used in the present invention are obtainable from Momentive Performance Materials Inc. as TOSPEARL® 120 and TOSPEARL® 3120.

### DESCRIPTION OF FIGURES

In FIGS. 1-7, coagulant and auxiliary materials used are specified within brackets, wherein CaAc2 is calcium acetate, CaCl2) is calcium chloride, CaOH2 is calcium hydroxide, MgAc2 is magnesium acetate and MgSO4 is magnesium sulfate. Na2CO3 and NH3 denote sodium carbonate and ammonia, CaHyp2 is calcium hypophosphite Ca(H₂PO₂)₂.

FIG. 1 shows the difference in haze (ΔHAZE) before and after hot water storage at 80° C. for 24 h for 1 mm press plates made from core-shell emulsion polymers (EP1-4) being processed via freeze coagulation (EP1-3) or thermal shear coagulation (EP4) and dewatering depending on the amount of sodium m_{Na} given in mmol/kg(impact modifier).

FIG. 2 shows the difference in haze (ΔHAZE) before and after hot water storage at 80° C. for 24 h for 1 mm press plates made from core-shell-shell emulsion polymers (EP5) being processed via freeze coagulation followed by a blending step with PMMA as blend component (wIM=36 wt %, wPMMA=64 wt %) depending on the amount of sodium mNa given in mmol/kg(impact modifier).

FIG. 3 shows the difference in haze (ΔHAZE) before and after hot water storage at 80° C. for 24 h for 1 mm press plates made from core-shell-shell emulsion polymer (EP6) being processed via freeze coagulation followed by a blending step with PMMA as blend component (w_{IM}=33 wt %, w_{PMMA}=67 wt %) depending on the amount of sodium m_{N}a given in mmol/kg(impact modifier).

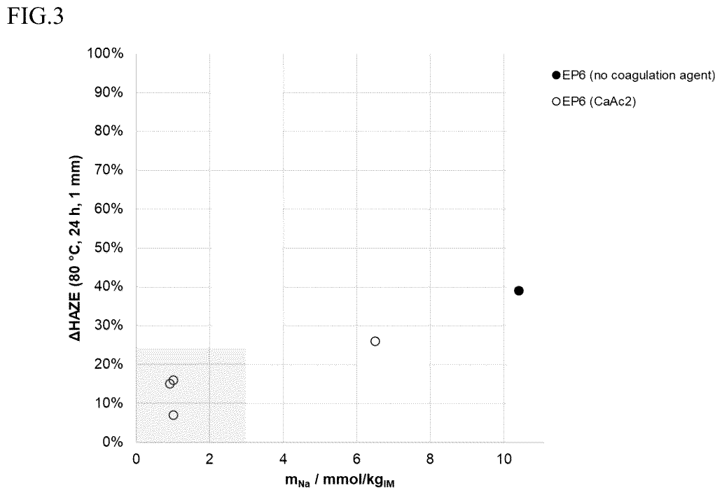

FIG. 4 shows the difference in haze (ΔHAZE) before and after hot water storage at 80° C. for 24 h for 1 mm press plates made from core-shell emulsion polymers (EP1-4) being processed via freeze coagulation (EP1-3) or thermal shear coagulation (EP4) and dewatering depending on the molar ratio of sodium to calcium, magnesium, (calcium+magnesium), and aluminum, resp., given in [mmol/kg(impact modifier)]/[mmol/kg(impact modifier)].

FIG. 5 shows the difference in haze (ΔHAZE) before and after hot water storage at 80° C. for 24 h for 1 mm press plates made from core-shell-shell emulsion polymers (EP5) being processed via freeze coagulation and dewatering followed by a blending step with PMMA as blend component (w_{IM}=36 wt %, w_{PMMA}=64 wt %) depending on the molar ratio of sodium to calcium, and magnesium resp., given in [mmol/kg(impact modifier)]/[mmol/kg(impact modifier)].

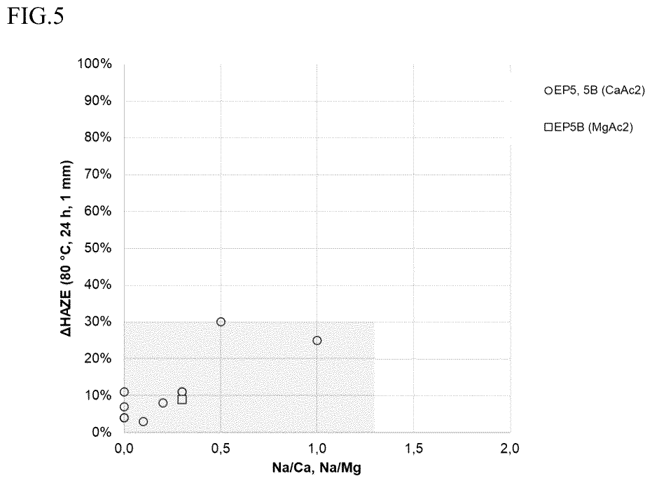

FIG. 6 shows the difference in haze (ΔHAZE) before and after hot water storage at 80° C. for 24 h for 1 mm press plates made from core-shell-shell emulsion polymer (EP6) being processed via freeze coagulation and dewatering followed by a blending step with PMMA as blend component (w_{IM}=33 wt %, W_{PMMA}=67 wt %) depending on the molar ratio of sodium to calcium, and magnesium resp., given in [mmol/kg(impact modifier)]/[mmol/kg(impact modifier)].

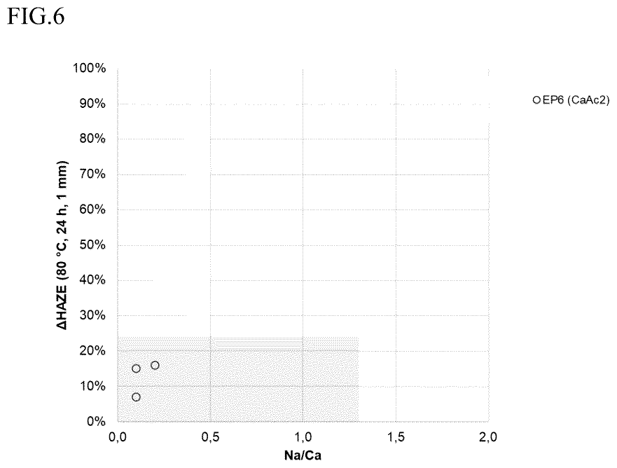

FIG. 7 shows the reduction of polymer loss via the wastewater during extrusion dewatering while processing the core-shell emulsion polymer EP4 via thermal shear coagulation (examples 67 to 73) depending on the molar ratio of sodium to calcium and magnesium, resp., given in [mmol/kg(impact modifier)]/[mmol/kg(impact modifier)].

The reduction of polymer loss (in wt %) was calculated as 1−wP/wP, 0, wherein wP, 0 is the amount of polymer in wastewater in reference example 67 (without addition of CaAc2) and wP is the amount of polymer in wastewater in the respective example.

The invention is described in more detail by the following examples and claims.

### EXAMPLES

### Overview

The emulsion polymers EP1, EP2 and EP3 having a core-shell structure were prepared and freeze coagulated (examples 1 to 40). The emulsion polymer EP5 and EP6 having a core-shell-shell structure were prepared and freeze coagulated (examples 41 to 61). Further, core-shell emulsion polymer EP1 was processed via thermal and freeze coagulation and mechanical dewatering (centrifugation) (examples 62 to 66). Core-shell emulsion polymer EP4 (examples 67 to 73) as well as core-shell-shell emulsion polymer EP5 (examples 74 to 79) was processed via continuous thermal shear coagulation and mechanical dewatering extrusion. Generally, core-shell-shell emulsion polymers were subsequently blended with PMMA.

Different coagulants (coagulation agents), such as calcium salts, magnesium salts or aluminium salts, were added as mentioned, before or after coagulation, in particular before coagulation unless specified otherwise.

The amounts of metal ions were determined in the emulsion polymers as described below. Further, test specimens were prepared, and haze values were determined as described below. The results are summarized in the following tables:
Table 2 (examples 1 to 40) contains the results for core-shell emulsion polymers EP1, EP2, EP3 being processed via freeze coagulation and mechanical dewatering (centrifugation). Unless otherwise specified, the coagulant (coagulation agent) was added before freezing.
Table 4 (examples 41 to 56) contains the results for core-shell-shell emulsion polymer EP5 being processed via freeze coagulation and mechanical dewatering (centrifugation) and subsequently blended with PMMA (polymethylmethacrylate). Unless otherwise specified, the coagulant (coagulation agent) was added before freezing.
Table 5 (examples 57 to 61) contains the results for core-shell-shell emulsion polymer EP6 being processed via freeze coagulation and mechanical dewatering (centrifugation) and subsequently blended with PMMA. Unless otherwise specified, the coagulant (coagulation agent) was added before freezing.
Table 6 (examples 62 to 66) contains the results for core-shell emulsion polymer EP4 being processed via thermal and freeze coagulation and mechanical dewatering (centrifugation). Unless otherwise specified, the coagulant (coagulation agent) was added before freezing.
Table 7 (examples 67 to 73) contains the results for core-shell emulsion polymer EP4 being processed via continuous thermal shear coagulation and mechanical dewatering extrusion. The examples are listed according to the chronological order of the tests performed.
Table 8 (examples 74 to 79) contains the results for core-shell-shell emulsion polymer EP5 being processed via continuous thermal shear coagulation and mechanical dewatering extrusion and subsequently blended with PMMA. The examples are listed according to the chronological order of the tests performed.

### I. Examples 1-40/Freeze-Coagulation of Emulsion Polymers EP1, EP2 and EP3 (Core-Shell Polymers)

Ia. Preparation of PMMA Latex Emulsion Polymers EP1, EP2 and EP3

In a polymerization vessel equipped with stirrer, feeding vessel and external cooling a water phase containing sodium hydroxymethylsulfate, acetic acid, iron (II) sulfate (FeSO₄) and an aqueous solution of seed latex, with 5% by weight solid content, was placed.

At a temperature of 55° C. (vessel outside temperature) emulsion I as described in table 1 was added sequentially over a time period of 20 min. After 10 min emulsion las described in table 1 was added sequentially within 2 h. The reaction mixture was stirred for 60 min, cooled to 45° C. and filtered over VA-steel (mesh size 90 μm). The emulsions I and II were each obtained by emulsifying the monomers and components as indicated in table 1.

The amounts are summarized in the following table 1.

TABLE 1
Emulsion polymerization of latex emulsion polymers EP1, EP2 and
EP3 of Examples 1-40, all amounts given in parts by weight

| | EP1 | EP2 | EP3 |
|---|---|---|---|
| Water phase | | | |
| Water | 1564.80 | 1549.90 | 1665.71 |
| Acetic acid | 0.20 | 0.20 | 0.19 |
| FeSO₄ | 0.004 | 0.004 | 0.048 |
| Na hydroxymethanesulfinate | 2.73 | 2.70 | 2.89 |
| | (in 40 g | (in 19.8 g | |
| | water) | water) | |
| Seed | 250.00 | 247.60 | 203.83 |
| Emulsion I | | | |
| Water | 732.95 | 745.80 | 639.32 |
| Tert-Butylhydroxyperoxide | 0.92 | 0.90 | 0.67 |
| Hostapur ® SAS 30 | 2.67 | 2.60 | 2.62 |
| Irganox ® 1076 | 0.93 | — | 0.91 |
| Butylacrylate | 911.48 | 902.80 | 911.33 |
| Allymethacrylate | 18.60 | 18.40 | 18.78 |
| Emulsion II | | | |
| Water | 1459.90 | 1446.00 | 1205.96 |
| Tert-butyl hydroxyperoxide | 1.83 | 1.80 | 1.35 |
| Hostapur ® SAS 30 | 4.02 | 4.00 | 4.14 |
| Irganox ® 1076 | 1.86 | — | 1.83 |
| 1-Dodecanethiol | 14.68 | 14.50 | 14.88 |
| Butyl acrylate | 148.63 | 147.20 | 148.76 |
| Methyl methacrylate | 1709.29 | 1693.00 | 1708.56 |

Hostapur ® SAS 30 (Clariant): Sodium C14-17 alkyl secondary sulfonate
Irganox ® 1076 (BASF): sterically hindered phenolic antioxidant

The aqueous polymer dispersions obtained had a solid content of 40-42% by weight.

### Ion Exchange

According to example 22 the emulsion polymer EP1 was subjected to an ion exchange step. A glass column with an inner diameter of 16 mm was filled with 25 mL of a strongly acidic ion exchanger in protonated form (H-form) (Dowex Marathon C). The free volume above the ion exchanger bed was filled manually with the aqueous emulsion polymerizate EP1. After that, the emulsion was pumped through the column from top to bottom at a mass flow rate of 2.5 g/min. Samples were taken at the column outlet and analyzed by AAS. The sodium content of the dispersion was below 10 ppm. All examples were frozen, sintered and dewatered as described in section Ib. below.

Ib. Coagulation, Sintering and Dewatering

In order to coagulate the emulsion polymers EP1, EP2, EP3 as described above an aqueous solution of a metal salt (coagulant), was added within 1-2 min at room temperature while stirring (in examples with the addition of coagulant). After complete coagulation of the latex, the dispersion was frozen at −18° C. for 24 h. According to comparative examples (without addition of coagulant) the emulsion polymers were frozen without addition of metal salts solution. In comparative examples 18 and 19 different amounts of Ca(Ac)₂ were added after freeze coagulation.

Afterwards the mixture was sintered at 80° C. for 24 h. The latex was cooled to room temperature and the particles were separated from the water via centrifugation at 1800 rpm. The centrifugation time was varied between 1.5-10 min resulting in different residual water content (w(H₂O)) in the coagulated and dewatered emulsion polymer.

The water content (w(H₂O)) after centrifugation was determined using an electronic moisture analyser (Sartorius MA45). The results are summarized in table 2 below.

After centrifugation the polymer was washed with deionized water (1 L) and again centrifuged. This procedure was carried out three times and the resulting polymer powder was dried at 50° C. for approx. 16-48 h to obtain a final water content of <1%. Test specimens with a thickness of 1 mm were prepared from said dried material as described below.

The content of metal ions (e.g. sodium content, calcium content and magnesium content) of the dewatered and dried impact modifiers (emulsion polymers) of examples 1 to 40 were determined as described below. The results are summarized in table 2.

Aqueous solutions of calcium acetate CaAc₂, calcium hydroxide Ca(OH)₂, calcium chloride CaCl₂, magnesium sulfate MgSO₄, magnesium acetate MgAc₂, aluminium sulfate Al₂(SO₄)₃, calcium hypophosphite Ca(H₂PO₂)₂ and ammonia NH₃, were used as coagulants. For example, CaAc₂ was used as aqueous solution comprising 1%, 10% or 15% by weight CaAc₂. The amounts of coagulant added to the emulsion polymer latex before or after coagulation are summarized in the following tables and are given as mol metal ion (e.g. Ca or Mg) based on the molar amount of sodium in the aqueous polymer dispersion. The sodium content in the aqueous polymer dispersion was in the range of 0.012 to 0.05% by weight, based on the total aqueous polymer dispersion. The sodium content resulted from the auxiliaries added during emulsion polymerization, such as emulsifiers, reducing agent, initiator or buffer used for pH adjustment, and was calculated based on the amounts of said auxiliaries added during polymerization.

Ic. Preparation of Moulding Compositions and Test Specimen

The dewatered and dried impact modifiers (emulsion polymers) according to examples 1-40 (based on emulsion polymers EP1, EP2, EP3) were compounded to obtain polymer granules. A 30 mm diameter single screw extruder was used to melt and mix the polymers. The melt temperature was 235° C. The extrudates emerging from the extruder die, were cooled in a water bath and pelletized.

Test specimens of 1 mm thickness and a diameter of 5 cm were prepared by hot pressing the granulates which were obtained as described above. The haze values and the transmission of the test specimens were determined as described below. The results are summarized in the following tables 2 and 2a (transmissions).

TABLE 2
Results for core-shell emulsion polymers (EP1-EP3) processed via
freeze coagulation and mechanical dewatering (centrifugation)

| | | Ca_{added} | | m_{Na} | m_{Ca} | | Haze (80° C. 1 mm). | | | |
|---|---|---|---|---|---|---|---|---|---|---|
| | | mol_{Ca}/ | w_{H2O} | mmol/ | mmol/ | Na/Ca | w_{IM} = 100 wt % | | | Coagulant/ |
| Example | EP | mol_{Na} | kg/kg | kg_{IM} | kg_{IM} | mol/mol | 0 | 24 h | Δ | Additive |
| 1a | 1 | — | 6% | 5.2 | 0.0 | — | 2% | 53% | 51% | — |
| 1b¹ | 3 | — | 12% | 7.5 | 0.0 | — | 4% | 36% | 32% | — |
| 2 | 1 | — | 19% | 5.2 | 0.0 | — | 4% | 49% | 45% | — |
| 3 | 1 | — | 16% | 4.8 | 0.0 | — | 3% | 38% | 35% | — |
| 4 | 1 | — | 6% | 4.1 | 0.0 | — | 3% | 38% | 35% | — |
| 5 | 2 | — | 7% | 4.8 | 0.0 | — | 3% | 48% | 45% | — |
| 6* | 2 | 0.5 | 7% | 2.2 | 3.2 | 0.7 | 3% | 15% | 12% | CaAc₂ |
| 7* | 1 | 1.0 | 31% | 1.3 | 3.5 | 0.4 | 5% | 13% | 8% | CaAc₂ |
| 8* | 2 | 1.0 | 7% | 1.7 | 4.0 | 0.4 | 3% | 11% | 8% | CaAc₂ |
| 9* | 3 | 1.0 | 21% | 0.8 | 4.2 | 0.2 | 3% | 6% | 3% | CaAc₂ |
| 10¹ | 3 | 1.0 | 20% | 4.5 | 5.2 | 0.9 | 3% | 65% | 62% | CaAc₂ |
| 11*¹ | 1 | 1.0 | 14% | 0.0 | 3.7 | 0.0 | 2% | 6% | 4% | CaAc₂ |
| 12* | 1 | 2.0 | 5% | 1.3 | 5.2 | 0.3 | 2% | 27% | 25% | CaAc₂ |
| 13* | 1 | 1.5 | 5% | 1.5 | 5.0 | 0.3 | 2% | 23% | 21% | CaAc₂ |
| 14* | 1 | 0.25 | 7% | 3.0 | 2.5 | 1.2 | 2% | 25% | 23% | CaAc₂ |
| 15* | 1 | 1.0 | 8% | 1.6 | 4.2 | 0.4 | 2% | 18% | 16% | CaAc₂ |
| 16* | 1 | 2.0 | 8% | 0.9 | 4.7 | 0.2 | 2% | 17% | 15% | CaAc₂ |
| 17* | 1 | 0.75 | 6% | 1.7 | 3.7 | 0.5 | 2% | 10% | 8% | CaAc₂ |
| 18¹ | 1 | 0.5 | 6% | 5.2 | 0.0 | — | 4% | 55% | 51% | CaAc₂ |
| 19² | 1 | 1.0 | 5% | 5.2 | 0.0 | — | 3% | 35% | 33% | CaAc₂ |
| 20* | 3 | 0.25 | 27% | 2.7 | 2.1 | 1.3 | 2% | 5% | 3% | CaAc₂ |
| 21* | 1 | 1.0 | 9% | 1.7 | 4.5 | 0.4 | 2% | 10% | 8% | CaAc₂. NH₃ |
| 22* | 1 | 1.0 | 17% | <0.9 | 8.0 | <0.11 | 2% | 4% | 2% | CaAc₂. IE |
| 23 | 3 | 1.0 | 25% | 6.1 | 8.2 | 0.7 | 10% | 74% | 63% | CaOH₂ |
| 24 | 3 | 1.0 | 21% | 6.2 | 8.5 | 0.7 | 10% | 47% | 36% | CaOH₂ |
| 25* | 3 | 1.0 | 18% | 0.8 | 7.7 | 0.1 | 9% | 26% | 17% | CaOH₂ |
| 26 | 3 | 1.0 | 30% | 6.2 | 5.2 | 1.2 | 4% | 85% | 82% | CaCl₂ |
| 27* | 1 | 1.0 | n.a. | 1.0 | 3.0 | 0.3 | 2% | 10% | 8% | Ca(H2PO2)2 |

| | | Mg_{added} | | m_{Na} | m_{Mg} | | Haze (80° C. 1 mm). | | | |
|---|---|---|---|---|---|---|---|---|---|---|
| | | mol_{Mg}/ | w_{H2O} | mmol/ | mmol/ | Na/Mg | w_{IM} = 100 wt % | | | Coagulant/ |
| Example | EP | mol_{Na} | kg/kg | kg_{IM} | kg_{IM} | mol/mol | 0 | 24 h | Δ | Additive |
| 28* | 1 | 1.0 | 6% | 1.8 | 4.1 | 0.4 | 2% | 12% | 10% | MgAc₂ |
| 29* | 1 | 1.0 | 8% | 1.9 | 3.1 | 0.6 | 2% | 10% | 8% | MgSO₄ |
| 30* | 1 | 1.0 | 37% | <0.9 | 3.2 | <0.3 | 3% | 17% | 14% | MgSO₄ |
| 31* | 1 | 1.0 | 36% | 1.0 | 3.0 | 0.3 | 2% | 5% | 3% | MgSO₄ |
| 32* | 1 | 2.0 | 39% | 1.7 | 2.1 | 0.8 | 2% | 7% | 4% | MgSO₄ |
| 33* | 1 | 1.0 | 2% | 1.9 | 3.5 | 0.5 | 2% | 17% | 14% | MgSO₄, NH₃ |
| 34* | 1 | 1.0 | 8% | 1.9 | 3.4 | 0.6 | 3% | 11% | 8% | MgSO₄, NH₃ |
| 35* | 1 | 1.0 | 4% | 2.0 | 3.5 | 0.6 | 2% | 19% | 18% | MgSO₄, NH₃ |
| 36* | 1 | 0.5 | 40% | 1.9 | 2.2 | 0.8 | 3% | 6% | 4% | MgSO₄, NH₃ |
| 37* | 1 | 1.0 | 39% | 1.4 | 3.0 | 0.5 | 3% | 6% | 3% | MgSO₄, NH₃ |
| 38* | 1 | 1.0 | 38% | 1.1 | 3.2 | 0.3 | 2% | 7% | 5% | MgSO₄, NH₃ |

| | | Al_{added} | | m_{Na} | m_{Al} | | Haze (80° C., 1 mm), | | | |
|---|---|---|---|---|---|---|---|---|---|---|
| | | mol_{Al}/ | w_{H2O} | mmol/ | mmol/ | Na/Al | w_{IM} = 100 wt % | | | Coagulant/ |
| Example | EP | mol_{Na} | kg/kg | kg_{IM} | kg_{IM} | mol/mol | 0 | 24 h | Δ | Additive |
| 39* | 1 | 1.0 | 15% | 0.0 | 2.8 | 0.0 | 1% | 12% | 10% | Al₂(SO₄)₃ |

| | | Ca_{added} | Mg_{added} | | m_{Na} | m_{Ca} | m_{Mg} | Na/(Mg + | Haze (80° C., 1 mm), | | | |
|---|---|---|---|---|---|---|---|---|---|---|---|---|
| | | mol_{Ca}/ | mol_{Mg}/ | w_{H2O} | mmol/ | mmol/ | mmol/ | Ca) | w_{IM} = 100 wt % | | | Coagulant/ |
| Ex. | EP | mol_{Na} | mol_{Na} | kg/kg | kg_{IM} | kg_{IM} | kg_{IM} | mol/mol | 0 | 24 h | Δ | Additive |
| 40* | 3 | 0.25 | 0.45 | 32% | 1.7 | 1.2 | 1.9 | 0.6 | 2% | 10% | 8% | CaAc₂, |
| | | | | | | | | | | | | MgSO₄ |

*Inventive example/
¹Without washing step/
²Addition of coagulant after freezing
IE: Ion exchange step

TABLE 2a
Test results transmission

| | | | Transmission | | | |
|---|---|---|---|---|---|---|
| | | W(IM) | (80° C., 1 mm) | | | Coagulant/ |
| Ex. | EP | wt. % | 0 h | 24 h | Δ | Additive |
| 11* | EP1 | 100 | 93% | 91% | 2% | CaAc₂ |
| 25* | EP1 | 100 | 93% | 85% | 8% | MgSO₄ |
| 26* | EP1 | 100 | 93% | 85% | 8% | MgAc₂ |
| 27* | EP1 | 100 | 93% | 86% | 7% | Al₂(SO₄)₃ |
| 28* | EP3 | 100 | 93% | 91% | 2% | CaAc₂ |

*Inventive example

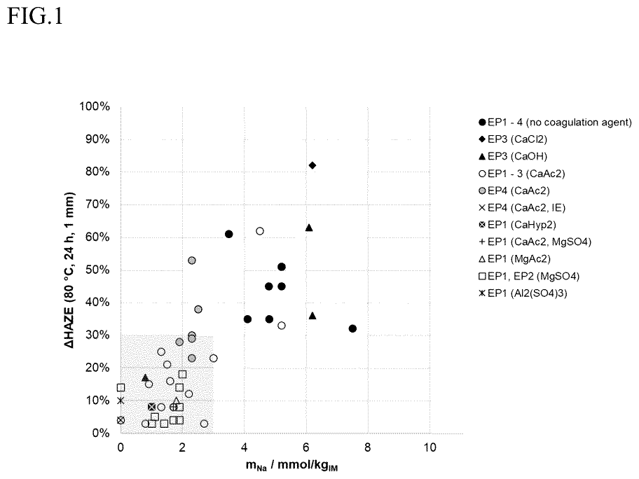

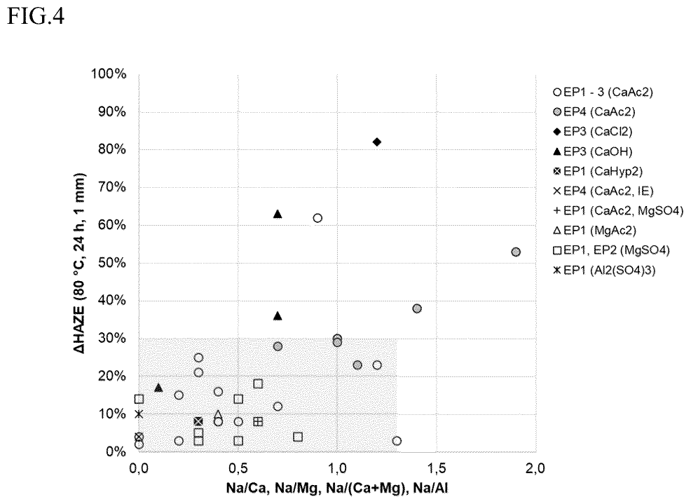

It is shown that improved hot water storage stability in view of the haze value as well as transmission is obtained if the amount of sodium is reduced to or to less than 3 mmol/kg, preferably less than 2 mmol/kg and simultaneously the molar ratio of alkali metal ions to multivalent ions (resulting from coagulant) is less or equal than 1.3 mol/mol. This is also demonstrated in the FIGS. 1 and 4 wherein the results according to examples 1 to 40 are summarized.

### II. Examples 41-61—Freeze-Coagulation of Emulsion Polymer EP5 and EP6 (Core-Shell-Shell Emulsion Polymer)

IIa. Preparation of PMMA Latex Emulsion Polymers

The emulsion polymer EP5 was prepared as follows:

In a polymerization vessel equipped with stirrer, feeding vessel and external cooling a water phase containing acetic acid, iron (II) sulfate (FeSO₄) and seed, containing 10 percent by weight of PMMA, was placed. At a temperature of 52° C. (vessel outside temperature) emulsion I as described in table 3 was added over a time period of 1 hour. In parallel 0.69 g sodium metabisulfite in 20 g water was added (during the first 10 min). After 15 min, 1.94 g sodium metabisulfite in 100 g water was added within 10 min parallel to the start of the addition of emulsion II as described in table 3. Emulsion II (table 3) was added within 2 h followed by a 50 min break. Emulsion II as described in table 3 was added simultaneously with 0.62 g sodium metabisulfite in 50 g water. The addition of sodium metabisulfite was finished within 10 min, emulsion III after 1 h. Afterwards the reaction mixture was stirred for 30 min, cooled to 35° C. and filtered over VA-steel (mesh size 100 μm).

The emulsion polymer EP6 were prepared as follows:

In a polymerization vessel equipped with stirrer, feeding vessel and external cooling water, sodium carbonate and seed, containing 10 percent by weight of PMMA, was placed. At a temperature of 83° C. (vessel inside temperature) emulsion I as described in table 3 was added over a time period of 90 minutes (10 minutes addition, 10 minutes break, 80 minutes addition). After a 10 min break, the addition of emulsion II as described in table 3 was started. Emulsion II was added within 2 h followed by a 30-45 min break. Emulsion III was added within 1 h. Afterwards the reaction mixture was stirred for 30 mi, cooled to room temperature (approx. 30 min) and filtered over VA-steel (mesh size 100 μm).

The emulsions I, II and III were each obtained by emulsifying the monomers and components as indicated in table 3.

TABLE 3
Emulsion polymerization of latex emulsion polymers EP5
and EP6 of Examples 41-61, all amounts given in g

| | EP5 | EP6 |
|---|---|---|
| Water phase | | |
| Water | 1691.00 | 1711.00 |
| Acetic acid | 0.10 | — |
| FeSO₄ | 0.0034 | — |
| Seed | 5.30 | 20.00 |
| Sodium carbonate | — | 1.37 |
| Emulsion I | | |
| Water | 732.69 | 785.92 |
| Sodium peroxodisulfate | 0.51 | 0.70 |
| Aerosol OT 75 | 4.67 | 5.60 |
| Ethyl acrylate | 29.40 | 47.60 |
| Methyl methacrylate | 703.47 | 1140.02 |
| Allymethacrylate | 2.21 | 2.38 |
| Emulsion II | | |
| Water | 628.65 | 542.39 |
| Sodium peroxodisulfate | 1.44 | 1.58 |
| Aerosol OT 75 | 7.46 | 7.20 |
| Butyl acrylate | 1218.72 | 1234.71 |
| Allymethacrylate | 19.53 | 22.95 |
| Styrene | 262.87 | 272.34 |
| Emulsion III | | |
| Water | 381.56 | 361.32 |
| Sodium peroxodisulfate | 0.44 | 0.70 |
| Aerosol OT 75 | 1.34 | 1.08 |
| Ethyl acrylate | 38.35 | 26.52 |
| Methyl methacrylate | 920.45 | 653.48 |
| 1-Dodecanethiol | 3.36 | — |

Aerosol OT 75: aqueous solution (75%) of sodium dioctyl sulfosuccinate

The aqueous polymer dispersions obtained had a solid content of 46-48% by weight (EP5) and 49-51% by weight (EP6).

IIb. Coagulation, Sintering and Dewatering

The emulsion polymers EP5 and EP6 were processed as described above under Ib.

IIc. Preparation of Moulding Compositions and Test Specimen

In order to compound dewatered and dried impact modifiers (emulsion polymers) according to examples 41 to 61 (based on emulsion polymers EP5, EP6) a Haake Rheomix 5000 measuring mixer 30 was used. 42-45 g of a polymer mixture consisting of polymethylmethacrylate PMMA_1 (copolymer of about 96 wt.-% methylmethacrylate (MMA) and 4 wt.-% methylacrylate having a weight averaged molecular weight of about Mw=110.000) and the impact modifier (amount see tables below) was slowly added to the mixing chamber. The amount of the impact modifier (w(IM)) is shown in tables 4 and 5. The polymer blend was mixed for 10 min at a temperature of 220-230° C. (30 rpm). The resulting melt was removed from the chamber and crushed with pliers.

Test specimens of 1 mm thickness and a diameter of 5 cm were prepared by hot pressing the granulates which were obtained as described above. The haze values and the transmission of the test specimens were determined as described below. The results are summarized in the following tables 4, 4a and 5.

Table 4 (examples 41 to 56) and table 5 (examples 57 to 61) contain the results concerning the core-shell-shell emulsion polymers EP5 and EP6 being processed via freeze coagulation and mechanical dewatering (centrifugation) and subsequently blended with polymethylmethacrylate PMMA_1. Unless otherwise specified the coagulant was added before freezing.

The water content in the emulsion polymer obtained after coagulation and dewatering is indicated as w(H2O). The amount of coagulant added is given as amount of multivalent metal cation (for example Ca(add)) in relation to the amount of sodium in the aqueous emulsion polymer composition, for example as mol_{Ca}/mol_{Na}. The amount of the impact modifier (emulsion polymer) in the moulding compositions respectively in the test specimen used for haze and transmission is indicated as w(IM) given in % by weight. The amount of metal ions in the impact modifier (dried emulsion polymer) is given as mmol/kg(impact modifier).

TABLE 4
Results for core-shell-shell emulsion polymers (EP5) processed via freeze coagulation
and mechanical dewatering (centrifugation) and subsequently blended with PMMA_1

| | | Ca_{added} | | m_{Na} | m_{Ca} | | Haze (80° C., 1 mm), | | | |
|---|---|---|---|---|---|---|---|---|---|---|
| | | mol_{Ca}/ | w_{H2O} | mmol/ | mmol/ | Na/Ca | w_{IM} = 36 wt %³ | | | Coagulant/ |
| Example | EP | mol_{Na} | kg/kg | kg_{IM} | kg_{IM} | mol/mol | 0 | 24 h | Δ | Additive |
| 41⁴ | 5 | — | 24% | 8.3 | 0 | — | 3% | 94% | 91% | — |
| 42⁴ | 5 | — | 15% | 7.0 | 0 | — | 2% | 83% | 81% | — |
| 43⁴ | 5 | — | 10% | 6.1 | 0 | — | 3% | 75% | 72% | — |
| 44 | 5 | — | 9% | 5.7 | 0 | — | 3% | 56% | 53% | — |
| 45* | 5 | 0.1 | 10% | 3.0 | 3.0 | 1.0 | 2% | 27% | 25% | CaAc₂ |
| 46* | 5 | 0.5 | 17% | 0.0 | 4.0 | 0.0 | 2% | 13% | 11% | CaAc₂ |
| 47* | 5 | 1.0 | 13% | 0.0 | 5.0 | 0.0 | 2% | 9% | 7% | CaAc₂ |
| 48* | 5 | 0.75 | 20% | 0.0 | 3.5 | 0.0 | 2% | 6% | 4% | CaAc₂ |
| 49* | 5 | 2.0 | 19% | 0.0 | 4.5 | 0.0 | 2% | 6% | 4% | CaAc₂ |
| 50* | 5 | 1.0 | 33% | 0.6 | 4.7 | 0.1 | 1% | 4% | 3% | CaAc₂ |
| 51* | 5 | 1.0 | 19% | 1.0 | 4.2 | 0.2 | 1% | 9% | 8% | CaAc₂ |
| 51.1* | 5 | 0.25 | 11% | 3.0 | 3.5 | 0.9 | 3% | 10% | 7% | CaAc₂ |

| | | Ca_{added} | | m_{Na} | m_{Ca} | | Haze (80° C., 1 mm), | | | |
|---|---|---|---|---|---|---|---|---|---|---|
| | | mol_{Ca}/ | w_{H2O} | mmol/ | mmol/ | Na/Ca | w_{IM} = 36 wt %⁵ | | | Coagulant/ |
| Example | EP | mol_{Na} | kg/kg | kg_{IM} | kg_{IM} | mol/mol | 0 | 24 h | Δ | Additive |
| 52* | 5 | 1.0 | 25% | 1.3 | 4.5 | 0.3 | 1% | 12% | 11% | CaAc₂, Na₂CO₃ |
| 53* | 5# | 1.0 | 31% | 2.0 | 4.2 | 0.5 | 2% | 32% | 30% | CaAc₂, Na₂CO₃ |
| 54* | 5 | 1.0 | — | 1.1 | 4.5 | 0.3 | 1% | 12% | 11% | CaAc₂, Na₂CO₃, |
| | | | | | | | | | | NH₃ |

| | | Mg_{added} | | m_{Na} | m_{Mg} | | Haze (80° C., 1 mm), | | | |
|---|---|---|---|---|---|---|---|---|---|---|
| | | mol_{Ca}/ | w_{H2O} | mmol/ | mmol/ | Na/Mg | w_{IM} = 36 wt %⁵ | | | Coagulant/ |
| Example | EP | mol_{Na} | kg/kg | kg_{IM} | kg_{IM} | mol/mol | 0 | 24 h | Δ | Additive |
| 55* | 5# | 1 | 32% | 1.8 | 5.8 | 0.3 | 2% | 11% | 9% | MgAc_{2;} Na₂CO₃ |
| 56* | 5# | 1 | 30% | 2.3 | 7.0 | 0.3 | 2% | 11% | 9% | MgAc_{2;} Na₂CO₃ |

*Inventive example
³w_{PMMA}_{_{—}}₁ = 64 wt %/
⁴Without washing step
⁵w_{PMMA}_{_{—}}₁ = 64 wt %
#Addition of sodium carbonate after polymerisation to adjust pH to 7-8

TABLE 5
Results for core-shell-shell emulsion polymer (EP6) processed via freeze coagulation
and mechanical dewatering (centrifugation) and subsequently blended with PMMA_1

| | | Ca_{add} | | m_{Na} | m_{Ca} | | Haze (80° C., 1 mm), | | | |
|---|---|---|---|---|---|---|---|---|---|---|
| | | mol_{Ca}/ | w_{H2O} | mmol/ | mmol/ | Na/Ca | w_{IM} = 33 wt %⁶ | | | Coagulant/ |
| Example | EP | mol_{Na} | kg/kg | kg_{IM} | kg_{IM} | mol/mol | 0 | 24 h | Δ | Additive |
| 57 | 6 | — | 8% | 10.4 | 0 | — | 2%⁷ | 41%⁷ | 39%⁷ | — |
| 58* | 6 | 1.0 | 22% | 0.9 | 6.2 | 0.1 | 1% | 16% | 15% | CaAc₂ |
| 59 | 6 | 0.1 | 10% | 6.5 | 2.2 | 2.9 | 2% | 28% | 26% | CaAc₂ |
| 60* | 6 | 1.0 | 22% | 1.0 | 6.5 | 0.2 | 1% | 18% | 16% | CaAc₂ |
| 61* | 6 | 1.5 | 24% | 1.0 | 6.7 | 0.1 | 1% | 9% | 7% | CaAc₂ |

*Inventive example
⁶w_{PMMA}_{_{—}}₁ = 67 wt %
⁷Estimation, i.e. typical values of similar sample

In example 41 the coagulated emulsion polymer was separated without washing step and without centrifugation; the polymer was separated from the water only via filtration.

In example 42 the coagulated emulsion polymer was separated without washing step and with centrifugation for 15 second. In example 43 the coagulated emulsion polymer was separated without washing step and with centrifugation for 10 minutes.

Examples 52 to 54 were prepared according to the description of EP5. Before coagulation, the pH of the dispersions was adjusted to pH 6.5-7 using sodium carbonate and, if necessary, ammonia solution. Coagulation, sintering and dewatering was performed according to the described procedure.

TABLE 4a
Test results transmission

| | | | Transmission | | | |
|---|---|---|---|---|---|---|
| | | w(IM) | (80° C., 1 mm) | | | |
| Example | EP | wt % | 0 h | 24 h | Δ | Coagulant |
| 48* | 5 | 36 | 93% | 89% | 4% | CaAc₂ |
| 49* | 5 | 36 | 92% | 91% | 1% | CaAc₂ |
| 52* | 5 | 36 | 93% | 86% | 7% | CaAc₂ |
| 54* | 5 | 36 | 93% | 85% | 8% | CaAc₂ |

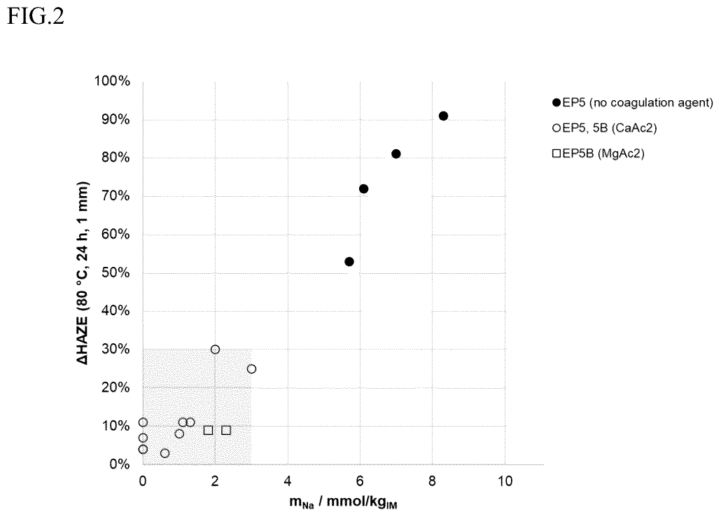

It is shown that improved hot water storage stability in view of the haze value as well as transmission is obtained if the amount of sodium is reduced to or to less than 3 mmol/kg, preferably less than 2 mmol/kg and simultaneously the molar ratio of alkali metal ions to multivalent ions (resulting from coagulant) is less or equal than 1.3 mol/mol. This is also demonstrated in the FIGS. 2,3 and 5, 6 wherein the results according to examples 41 to 61 are summarized.

### III. Examples 62-66 (Preparation of PMMA Impact Modifiers Processed Via Thermal and Freeze Coagulation)

IIIa. Preparation of PMMA Latex Emulsion Polymers

A core-shell emulsion polymer EP4 formed in two stages (impact modifier for PMMA moulding compounds) as described above for EP1 to EP3, wherein the following composition was processed:
Stage I:Butyl acrylate/allyl methacrylate in ratio 98:2
Stage II: Methyl methacrylate/butyl acrylate/dodecylmercaptane in a ratio 92:8:0.8
Mass ratio of I/II=33.4/66.6
Mass ratio of polymer phase/aqueous phase=41/59
Average particle size: about 124 nm
   IIIb. Coagulation, Sintering and Dewatering
   Coagulation was carried out as described in the following:

### Example 62

A 25 L stainless steel stirred vessel was filled with 15 kg of the aqueous emulsion polymerizate EP4 and heated while stirring with a blade stirrer at 97 rpm. During the heating phase, a pressure-resistant cylinder made of stainless-steel was connected to the stirred vessel via a ball valve. The cylinder contained 62.6 g of a 15 wt % aqueous MgSO4 solution and 62.6 g of a 1 wt % aqueous ammonia solution. The cylinder was pressurized with nitrogen at a pressure higher than the internal pressure of the stirred vessel. As an internal temperature of 106° C. in the vessel was reached, the ball valve was opened, and the cylinder contents were rapidly introduced into the dispersion by the pressure difference. The dispersion was then stirred for additional 57 min. with continued heating during which the internal temperature increased to 133° C. After that the content of the vessel was cooled down and the vessel was opened. The vessel contained coagulated dispersion as well as a milky aqueous phase.

### Example 63

A 25 L stainless steel stirred vessel was filled with 15 kg of the aqueous emulsion polymerizate EP4 and heated while stirring with a blade stirrer at 111 rpm. During the heating phase, a pressure-resistant cylinder made of stainless-steel was connected to the stirred vessel via a ball valve. The cylinder contained 62.8 g of a 15 wt % aqueous MgSO₄ solution and 62.7 g of a 1 wt % aqueous ammonia solution. The cylinder was pressurized with nitrogen at a pressure higher than the internal pressure of the stirred vessel. As an internal temperature of 152° C. in the vessel was reached, the ball valve was opened, and the cylinder contents were rapidly introduced into the dispersion by the pressure difference. The dispersion was then stirred for additional 82 min. with continued heating during which the internal temperature increased to 153° C. After that the content of the vessel was cooled down and the vessel was opened. The vessel contained coagulated dispersion as well as a milky aqueous phase.

### Example 64

A 2.4 L stainless steel stirred vessel was filled with 2004 g of the aqueous emulsion polymerizate EP4 and heated while stirring with a 3-stage INTERMIG stirrer at 150 rpm. During the heating phase, a pressure-resistant cylinder made of stainless-steel was connected to the stirred vessel via a ball valve. The cylinder contained 8.4 g of a 15 wt % aqueous MgSO4 solution and 8.4 g of a 1 wt % aqueous ammonia solution. The cylinder was pressurized with nitrogen at a pressure higher than the internal pressure of the stirred vessel. As an internal temperature of 195° C. in the vessel was reached, the ball valve was opened, and the cylinder contents were rapidly introduced into the dispersion by the pressure difference. The dispersion was then stirred for additional 10 min. with continued heating during which the internal temperature increased to 209° C. After that the content of the vessel was cooled down and the vessel was opened. The vessel contained coagulated dispersion as well as a milky aqueous phase.

### Example 65

A 2.4 L stainless steel stirred vessel was filled with 2008 g of the aqueous emulsion polymerizate EP4 and heated while stirring with a blade stirrer at 150 rpm. During the heating phase, a pressure-resistant cylinder made of stainless-steel was connected to the stirred vessel via a ball valve. The cylinder contained 8.5 g of a 15 wt % aqueous MgSO4 solution and 8.7 g of a 1 wt % aqueous ammonia solution. The cylinder was pressurized with nitrogen at a pressure higher than the internal pressure of the stirred vessel. As an internal temperature of 223° C. in the vessel was reached, the ball valve was opened, and the cylinder contents were rapidly introduced into the dispersion by the pressure difference. The dispersion was then stirred for additional 10 min. with continued heating during which the internal temperature increased to 224° C. After that the content of the vessel was cooled down and the vessel was opened. The vessel contained coagulated dispersion as well as a milky aqueous phase.

### Example 66

A 2.4 L stainless steel stirred vessel was filled with 2000 g of the aqueous emulsion polymerizate EP4 and heated while stirring with a blade stirrer at 150 rpm. During the heating phase, a pressure-resistant cylinder made of stainless-steel was connected to the stirred vessel via a ball valve. The cylinder contained 8.95 g of a 15 wt % aqueous MgSO4 solution. The cylinder was pressurized with nitrogen at a pressure higher than the internal pressure of the stirred vessel. As an internal temperature of 195° C. in the vessel was reached, the ball valve was opened, and the cylinder contents were rapidly introduced into the dispersion by the pressure difference. The dispersion was then stirred for additional 10 min. with continued heating during which the internal temperature increased to 210° C. After that the content of the vessel was cooled down and the vessel was opened. The vessel contained coagulated dispersion as well as a milky aqueous phase.

All examples were frozen, sintered and dewatered as described in section Ib.

IIIc. Preparation of Moulding Compositions and Test Specimen

The dewatered and dried impact modifiers (emulsion polymers) according to examples 62-66 (based on emulsion polymer EP4) were compounded as described in section Ic. Test specimens of 1 mm thickness and a diameter of 5 cm were prepared by hot pressing the granulates as described in section Ic. The results are summarized in the following table 6.

TABLE 6
Results for core-shell emulsion polymer EP4 processed via thermal
and freeze coagulation and mechanical dewatering (centrifugation)

| | | | | | | | Haze (80° C., 1 mm), | | | |
|---|---|---|---|---|---|---|---|---|---|---|
| | | Mg_{added} | w_{H2O} | m_{Na} | m_{Mg} | Na/Mg | w_{IM} = 100 wt % | | | Coagulant/ |
| | EP | mol_{Mg}/mol_{Na} | kg/kg | mmol/kg_{IM} | mmol/kg_{IM} | mol/mol | 0 | 24 h | Δ | Additive |
| 62* | 4 | 1.0 | n.a. | <0.9 | 3.0 | <0.3 | 2% | 3% | 1% | MgSO₄, NH₃ |
| 63* | 4 | 1.0 | 8% | 1.7 | 3.6 | 0.5 | 2% | 7% | 5% | MgSO₄, NH₃ |
| 64* | 4 | 1.0 | 13% | <0.9 | 3.5 | <0.3 | 2% | 4% | 1% | MgSO₄, NH₃ |
| 65* | 4 | 1.0 | 14% | <0.9 | 3.5 | <0.3 | 2% | 17% | 15% | MgSO₄, NH₃ |
| 66* | 4 | 1.0 | 11% | 1.2 | 3.4 | 0.3 | 2% | 17% | 15% | MgSO₄, NH₃ |

*Inventive example

### IV. Examples 67 to 73 (Preparation of PMMA Impact Modifiers Using Thermal Shear Coagulation)

IVa. Preparation of PMMA Latex Emulsion Polymer

A core-shell emulsion polymer EP4 as described above (section IIIa.) was used.

IVb. Coagulation, Sintering and Dewatering

Different amounts of calcium acetate (CaAc₂) were added in form of an aqueous solution (1 wt %, 10 wt % or 15 wt %) to the emulsion polymer latex EP4 before shear coagulation. Calcium acetate (CaAc₂) was added in an amount of 0.1 to 2 mol Ca, based on the molar amount of sodium in the aqueous polymer dispersion (see table 7, Ca(add)). The amount of sodium in the aqueous dispersion was about 0.013% by weight, based on the aqueous dispersion. The sodium content resulted from the auxiliaries added during emulsion polymerization, such as emulsifiers, reducing agent, initiator or buffer used for pH adjustment, and was calculated based on the amounts of said auxiliaries added during polymerization.

The latex was pumped into the cylinder (zone 1) of a counter-rotating twin-screw extruder. The coagulation zone was divided into several major zones, beginning with first zone where the dispersion was fed into the extruder. The specified temperatures of the heat jackets of the coagulation zones in the extruder were in the range of 150 to 210° C. The last zone was followed by a dewatering zone separating the polymer melt.

Via the line, the collection tank for the separated water was maintained under a pressure of at least 28 bar. A water flow typically containing 8-10% polymer was drawn off via the valve. The feed flow to the degassing extruder was regulated by a valve such that the melt pressure was kept at 40-60 bar.

In the degassing extruder the residual quantities of volatile constituents are separated from the polymer. The extruded or granulated material discharged at a granulating nozzle has a residual moisture content of less than 5% by weight.

The polymer concentration in the water collected in the dewatering zone was analysed an electronic moisture analyser HE53 from Mettler Toledo heating up to 160° C. The results (see following table 7) are given based in % reduction of polymer loss based on the reference example Ex.67 (without addition of CaAc₂). The reduction of polymer loss (Red.Loss), given in wt %, is calculated:

$$Red . Loss ( in wt \% ) = 1 - {w}_{P , A} / {w}_{P , A , 0} ,$$

wherein w_{P,A,0} is the amount of polymer in wastewater in reference example 43 (without addition of CaAc₂) and w_{P,A} is the amount of polymer in wastewater in the respective example.
   IVc. Preparation of Moulding Compositions and Test Specimen

Test specimens of 1 mm thickness and a diameter of 5 cm were prepared by hot pressing of the granulate obtained after the extrusion process. The haze of the test specimens before and after hot water storage as well as the amount of sodium and calcium in the dried emulsion polymer were determined as described below.

The results are summarized in table 7, wherein the examples are given in chronological order. Firstly, the emulsion polymer latex EP4 without addition of CaAc₂ was fed into the extruder, subsequently the emulsion polymer latex A4 with addition of CaAc₂ solution having 10 wt % and 15 wt % (in this order) were fed. Afterwards, emulsion polymer latex EP4 without addition of CaAc₂ was fed. The samples were taken after a stable process was reached.

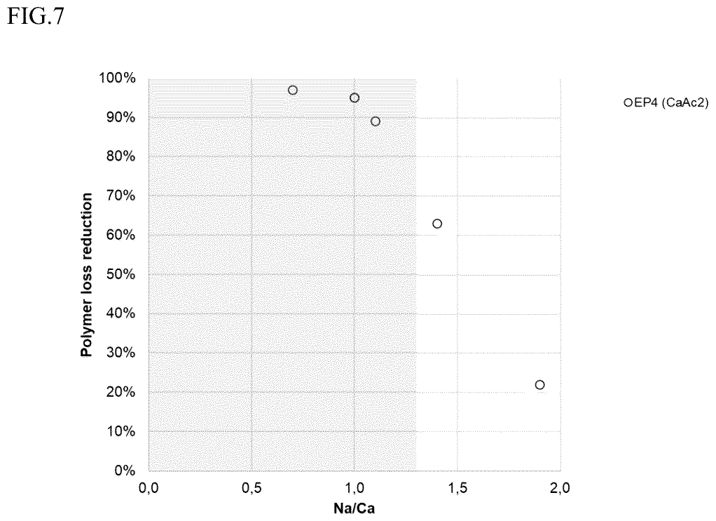

It is shown that improved hot water storage stability is obtained if the amount of sodium is reduced to or to less than 3 mmol/kg and simultaneously the molar ratio of alkali metal ions to multivalent ions (resulting from coagulant) is less or equal than 1.3 mol/mol. This is also demonstrated in FIG. 7, wherein the results according to examples 67 to 73 are summarized.

It is shown that the reduction of polymer loss (Red.Loss (in wt %) see above) is significantly increased at about 90% when the molar ratio of sodium to calcium is less than 1,3. In particular, these advantageous results are obtained when the amount of sodium in the emulsion polymer is below 3 mmol/kg and the amount of calcium is more than 2 mmol/kg.

TABLE 7
Results for core-shell emulsion polymer EP4 processed via continuous thermal
shear coagulation and mechanical dewatering extrusion in chronological order.

| | | Ca_{add} | | m_{Na} | m_{Ca} | | Haze (80° C., 1 mm), | | | Red. | |
|---|---|---|---|---|---|---|---|---|---|---|---|
| | | mol_{Ca}/ | w_{H2O} | mmol/ | mmol/ | Na/Ca | w_{IM} = 100 wt % | | | Loss | Coagulant/ |
| Example | EP | mol_{Na} | kg/kg | kg_{IM} | kg_{IM} | mol/mol | 0 | 24 h | Δ | kg/kg | Additive |
| 67 | 4 | — | <1% | 3.5 | 0.0 | — | 3% | 64% | 61% | 0% | — |
| 68 | 4 | 0.5 | <1% | 2.5 | 1.8 | 1.4 | 3% | 41% | 38% | 63% | CaAc₂ |
| 69* | 4 | 1.0 | <1% | 2.3 | 2.3 | 1.0 | 3% | 33% | 30% | 95% | CaAc₂ |
| 70* | 4 | 1.0 | <1% | 2.3 | 2.3 | 1.0 | 3% | 32% | 29% | 95% | CaAc₂ |
| 71* | 4 | 1.0 | <1% | 1.9 | 2.7 | 0.7 | 3% | 31% | 28% | 97% | CaAc₂ |
| 72* | 4 | 0.76 | <1% | 2.3 | 2.1 | 1.1 | 3% | 26% | 23% | 89% | CaAc₂ |
| 73 | 4 | — | <1% | 2.3 | 1.2** | 1.9 | 4% | 57% | 53% | 22% | CaAc₂ |

*Inventive example
**Residual from previous state point (example 72)

### V. Examples 74 to 79 (Preparation of PMMA Impact Modifiers Using Thermal Shear Coagulation)

Va. Preparation of PMMA Latex Emulsion Polymer

A core-shell emulsion polymer EP5 was prepared as described above (section IIa).

Vb. Coagulation, Sintering and Dewatering

Coagulation and dewatering of emulsion polymer EP5 was prepared as described above for examples 67 to 73 (section IVb.). The emulsion polymer EP5 was processed via thermal shear coagulation and mechanical dewatering extrusion and subsequently blended with polymethylmethacrylate PMMA_1.

Vc. Preparation of Moulding Compositions and Test Specimen

Test specimens of 1 mm thickness and a diameter of 5 cm were prepared as described above for examples 67 to 73 (section IVc.) by hot pressing of the granulate obtained after the extrusion process. The haze of the test specimens before and after hot water storage as well as the amount of sodium and calcium in the dried emulsion polymer were determined as described below. The results are summarized in table 8, wherein the examples are given in chronological order.

TABLE 8
Results for core-shell emulsion polymer EP5 processed via continuous thermal shear coagulation
and mechanical dewatering extrusion and subsequently blended with PMMA_1 in chronological order.

| | | | | | | | Haze (80° C., 1 mm), | | | |
|---|---|---|---|---|---|---|---|---|---|---|
| | | Mg_{add} | w_{H2O} | m_{Na} | m_{Mg} | Na/Mg | w_{IM} = 48 wt %⁸ | | | Coagulant/ |
| Example | EP | mol_{Mg}/mol_{Na} | kg/kg | mmol/kg_{IM} | mmol/kg_{IM} | mol/mol | 0 | 24 h | Δ | Additive |
| 74 | 5# | ~0 | <1% | 5.7 | — | — | 1% | 86% | 85% | — |
| 75 | 5# | 0.2 | <1% | 5.7 | 1.7 | 3.4 | 2% | 77% | 75% | MgAc₂, |
| | | | | | | | | | | Na₂CO₃ |
| 76 | 5# | 0.8 | <1% | 5.2 | 3.0 | 1.7 | 1% | 79% | 78% | MgAc₂, |
| | | | | | | | | | | Na₂CO₃ |
| 77 | 5# | 1.4 | <1% | 5.7 | 3.8 | 1.5 | 1% | 85% | 84% | MgAc₂, |
| | | | | | | | | | | Na₂CO₃ |
| 78 | 5# | 1.1 | <1% | 5.7 | 3.2 | 1.8 | 1% | 84% | 83% | MgAc₂, |
| | | | | | | | | | | Na₂CO₃ |
| 79 | 5# | ~0 | <1% | 6.5 | — | — | 1% | 86% | 85% | — |

⁸wPMMA_1 = 52 wt %
#Addition of sodium carbonate after polymerisation to adjust pH to 7-8

### VI. Test Methods

VIa. Hot Water Haze

The test specimens (obtained by hot pressing, having 1 mm thickness and a diameter of 5 cm) were stored in deionized water at 80° C. for 24 hours. Haze values were determined before and after hot water storage according to ASTM D1003-13 using a Hazemeter BYK Gardner haze-gard i.

These test specimens which were prepared as described above were tested with a BYK Gardner haze-gard i haze meter at 23° C. in accordance with the ASTM D1003-13 in the original state (“Haze before”) and after hot water storage in deionized water at 80° C. for 24 hours. It should be noted that—according to ASTM D1003-13—materials having a haze value greater than 30% are considered “diffusing” and should be tested in accordance with Practice for Goniometric Optical Scatter Measurements (E2387). Since the focus of the current work is on transparent materials having haze value less than 30%, the haze values greater than 30% are reported in order to illustrate tendencies.

These haze values and the difference (HAZE/Δ) of haze value after and before hot water storage (HAZE/24 h−HAZE/0 h) are summarized in the tables above.

The transmission (given in %) before and after hot water storage was determined accordingly in accordance with the ASTM D1003-13.

VIb. Content of Metal Ions

In order to determine the metal ion content (e.g. Na and Ca) a microwave-assisted digestion of the dried emulsion polymer with nitric acid was performed. Afterwards the content of the relevant ions was determined via atomic absorption spectroscopy.

VIc. Water Content

If not defined otherwise, the water content (residual water) was determined using an electronic moisture analyser heating up to 85° C. (Sartorius MA45). The reduction of polymer loss was determined as described above, section IVb.-Coagulation, sintering and dewatering.

1. A poly(meth)acrylate impact modifier comprising at least one multiphase alkyl (meth)acrylate emulsion polymer, wherein the poly(meth)acrylate impact modifier comprises at least one multivalent metal ion and less than or equal to 3.0 mmol/kg, based on a solid content of the poly(meth)acrylate impact modifier, of alkali metal ions, and wherein a molar ratio of alkali ions to multivalent metal ions is less than or equal to 1.3.

2. The poly(meth)acrylate impact modifier according to claim 1, wherein a molar ratio of multivalent metal ions to alkali ions is more than or equal to 0.8.

3. The poly(meth)acrylate impact modifier according to claim 1, wherein the poly(meth)acrylate impact modifier comprises more than or equal to 0.5 mmol/kg, based on the solid content of the poly(meth)acrylate impact modifier, of multivalent metal ions.

4. The poly(meth)acrylate impact modifier according to claim 1, wherein the poly(meth)acrylate impact modifier comprises from 0 to 3.0 mmol/kg, based on the solid content of the poly(meth)acrylate impact modifier, of alkali metal ions, and from 0.5 to 20.0 mmol/kg, based on the solid content of the poly(meth)acrylate impact modifier, of multivalent metal ions.

5. The poly(meth)acrylate impact modifier according to claim 1, wherein the alkali metal ions are selected from the group consisting of sodium and potassium, and the multivalent metal ions are selected from the group consisting of alkaline earth metals, zinc, calcium, magnesium and aluminium ions.

6. The poly(meth)acrylate impact modifier according to claim 1, wherein the at least one multiphase alkyl (meth)acrylate emulsion polymer is obtained by emulsion polymerization and comprises a core and at least one shell.

7. The poly(meth)acrylate impact modifier according to claim 1, wherein the at least one multiphase alkyl (meth)acrylate emulsion polymer comprises:
at least 10% by weight of at least one C₁-C₁₀ alkyl methacrylate;
5 to 80% by weight of at least one C₁-C₁₀ alkyl acrylate or at least one conjugated diene;
0 to 2% by weight of at least one crosslinking monomer; and
0 to 15% by weight of optionally further monomers.

8. The poly(meth)acrylate impact modifier according to claim 1, wherein the at least one multiphase alkyl (meth)acrylate emulsion polymer is a core-shell emulsion polymer comprising:
A1) 10 to 95% by weight, based on the total core-shell emulsion polymer, of a soft elastomeric core A1, having a glass transition temperature T_{g} below −10° C., A1 comprising:
A1.1) 50 to 99.5% by weight, based on A1, of at least one C₁-C₁₀ alkyl acrylate;
A1.2) 0.5 to 5% by weight, based on A1, of at least one crosslinking monomer, having two or more ethylenically unsaturated groups;
A1.3) 0 to 10% by weight, based on A1, of at least one further ethylenically unsaturated, free radically polymerizable monomer; and
B1) 5 to 90% by weight, based on the total core-shell emulsion polymer, of a hard shell B1, having a glass transition temperature T_{g} above 70° C., B1 comprising:
B1.1) 80 to 100% by weight, based on B1, of at least one C₁-C₆ alkyl methacrylate; and
B1.2) 0 to 20% by weight, based on B1, of at least one further ethylenically unsaturated, free radically polymerizable monomer.

9. The poly(meth)acrylate impact modifier according to claim 1, wherein the at least one multiphase alkyl (meth)acrylate emulsion polymer is a core-shell emulsion polymer comprising:
A2) 5 to 40% by weight, based on the total core-shell emulsion polymer, of a hard, non-elastomeric core A2, having a glass transition temperature T_{g} above 50° C., A2 comprising:
A2.1) 80 to 100% by weight, based on A2, of at least one C₁-C₆ alkyl methacrylate;
A2.2) 0 to 20% by weight, based on A2, of at least one further ethylenically unsaturated, free radically polymerizable monomer;
A2.3) 0 to 5%) by weight, based on A1, of at least one crosslinking monomer, having two or more ethylenically unsaturated groups; and
B2) 20 to 75% by weight, based on the total core-shell emulsion polymer, of a soft elastomeric intermediate shell B2, having a glass transition temperature T_{g} below 0° C., B2 comprising:
B2.1) 45 to 99.5% by weight, based on B2, of at least one C₁-C₁₀ alkyl acrylate;
B2.2) 0.5 to 5% by weight, based on B2, of at least one crosslinking monomer, having two or more ethylenically unsaturated groups;
B2.3) 0 to 50% by weight, based on B2, of at least one further ethylenically unsaturated, free radically polymerizable monomer; and
C2) 15 to 60% by weight, based on the total core-shell emulsion polymer, of a hard outer shell C2, having a glass transition temperature T_{g} above 50° C., C2 comprising:
C2.1) 80 to 100% by weight based on C2, of at least one C₁-C₆ alkyl methacrylate; and
C2.2) 0 to 20% by weight based on C2, of at least one further ethylenically unsaturated free radically polymerizable monomer.

10. A method for producing a poly(meth)acrylate impact modifier according to claim 1 comprising at least one multiphase alkyl (meth)acrylate emulsion polymer, the method comprising:
(i) preparation of at least one multiphase alkyl (meth)acrylate emulsion polymer via emulsion polymerization, wherein the at least one multiphase alkyl (meth)acrylate emulsion polymer is obtained in form of a latex; and
(ii) coagulation and dewatering of the latex obtained in (i),
wherein the coagulation is carried out by physical coagulation,
wherein a dewatered alkyl (meth)acrylate emulsion polymer is obtained,
wherein the dewatered alkyl (meth)acrylate emulsion polymer comprises less than or equal to 3.0 mmol/kg, based on a solid content of the at least one alkyl (meth)acrylate emulsion polymer, of alkali metal ions, and wherein a molar ratio of alkali ions to multivalent metal ions in the dewatered alkyl (meth)acrylate emulsion polymer, is less than or equal to 1.3, and
wherein a coagulant comprising at least one salt of a multivalent metal ion, is added to the at least one multiphase alkyl(meth)acrylate emulsion polymer before and/or during coagulation.

11. The method according to claim 10, wherein the dewatered alkyl (meth)acrylate emulsion polymer obtained in (ii) comprises from 0 to 3.0 mmol/kg, based on the solid content of the at least one alkyl (meth)acrylate emulsion polymer, of alkali metal ions, and from 0.5 to 20.0 mmol/kg, based on the solid content of the at least one alkyl (meth)acrylate emulsion polymer, of multivalent metal ions.

12. The method according to claim 10, wherein the coagulant is an aqueous solution of at least one salt of a multivalent metal ion, selected from the group consisting of alkaline earth metals, zinc, calcium, magnesium and aluminium.

13. The method according to claim 10, wherein in (ii) the coagulation is carried out by freeze-coagulation and the dewatering of the coagulated emulsion polymer is carried out by centrifugation, wherein the water content of the dewatered emulsion polymer is in the range of 5 to 40% by weight, based on the dewatered emulsion polymer, and wherein the method comprises;
(iii) optionally washing the dewatered alkyl (meth)acrylate emulsion polymer; and
(iv) drying the dewatered alkyl (meth)acrylate emulsion polymer obtained in ii) or iii), wherein the poly(meth)acrylate impact modifier is obtained as a polymer powder.

14. The method according to claim 10, wherein in (ii) the coagulation and the dewatering is carried out by thermal shear coagulation, wherein the latex obtained in (i) is introduced into an extruder line, the extruder line comprising:
at least one coagulation zone,
at least one dewatering zone, and
at least one degassing zone,
wherein the poly(meth)acrylate impact modifier is obtained as a polymer granulate.

15. A thermoplastic moulding composition, comprising:
1 to 100% by weight, based on a total moulding composition, of at least one poly(meth)acrylate impact modifier according to claim 1;
0 to 99% by weight, based on the total moulding composition, of at least one thermoplastic (meth)acrylate polymer, and
0 to 50% by weight, based on the total moulding composition, of one or more additives and/or one or more additional polymeric components.

16. A method for producing a thermoplastic moulding composition according to claim 15, the method comprising:
xi) mixing 1 to 100% by weight, based on the total thermoplastic moulding composition, of at least one poly(meth)acrylate impact modifier; 0 to 99% by weight, based on the total thermoplastic moulding composition, of at least one thermoplastic (meth)acrylate polymer; and optionally 0 to 50% by weight, of one more additive and/or one or more additional polymeric component; and
xii) melt compounding of the mixture obtained in xi).

17. A moulded article or semi-finished product produced from a thermoplastic moulding composition according to claim 15.

18. The moulded article or semi-finished product according to claim 17, wherein the moulded article or semi-finished product comprises:
up to 50% by weight, based on the total moulded article or semi-finished product, of at least one additive selected from the group consisting of dyes, pigments, organic scattering particles and inorganic scattering particles.

19. The moulded article or semi-finished product according to claim 17, wherein the moulded article or semi-finished product has a haze value, determined after water storage at 80° C. for 24 h according to ASTM D1003-13, of less than or equal to 25.0% for material thicknesses of 1 mm.
